(19) United States
(12) Patent Application Publication
(10) Pub. No.: US 2025/0013882 A1
(43) Pub. Date: Jan. 9, 2025

(54) DOUBLY-EXPONENTIALLY ACCELERATED PARTICLE METHODS AND SYSTEMS FOR NONLINEAR CONTROL

(71) Applicant: Paul Burchard, Jersey City, NJ (US)

(72) Inventor: Paul Burchard, Jersey City, NJ (US)

(21) Appl. No.: 18/770,217

(22) Filed: Jul. 11, 2024

Related U.S. Application Data
(63) Continuation of application No. PCT/US24/36713, filed on Jul. 3, 2024.
Application No. PCT/US24/36713 is a continuation of application No. 18/750,304, filed on Jun. 21, 2024, now abandoned.
(60) Provisional application No. 63/512,510, filed on Jul. 7, 2023.
(60) Provisional application No. 63/603,149, filed on Nov. 28, 2023.
(60) Provisional application No. 63/573,967, filed on Apr. 3, 2024.

(51) Int. Cl. G06N 5/01

(52) U.S. Cl. CPC G06N 5/01

(57) ABSTRACT

Aspects herein describe new methods of determining optimal actions to achieve high-level objectives based on an optimized chosen statistic. At least one high-level objective, along with various observational data about the world, is identified by a computational unit. The computational unit determines, through a particle method, an optimal course of action. The particle method is doubly-exponentially accelerated based on one or more acceleration methods. The doubly-exponentially accelerated particle method comprises alternating backward and forward sweeps of a coupled induction loop to optimize a selection policy and test for convergence to determine said optimal course of action. In one embodiment a user inputs a high-level objective into a cell phone which senses observational data. The cell phone communicates with a server that provides instructions. The server determines an optimal course of action via the doubly-exponentially accelerated particle method, and the cell phone then displays the instructions to the user.

### CROSS REFERENCE TO RELATED APPLICATIONS

This application claims priority to provisional U.S. Application Ser. No. 63/512,510, filed Jul. 7, 2023, entitled “ACCELERATED PARTICLE METHODS AND SYSTEMS FOR NONLINEAR CONTROL”; provisional U.S. Application Ser. No. 63/603,149, filed Nov. 28, 2023, entitled “ACCELERATED PARTICLE METHODS AND SYSTEMS FOR NONLINEAR CONTROL”; provisional U.S. Application Ser. No. 63/573,967, filed Apr. 3, 2024, entitled “DOUBLY-EXPONENTIALLY ACCELERATED PARTICLE METHODS AND SYSTEMS FOR NONLINEAR CONTROL”; and is a Continuation of Patent Cooperation Treaty Application Ser. No. PCT/US2024/36713, filed Jul. 3, 2024, entitled “DOUBLY-EXPONENTIALLY ACCELERATED PARTICLE METHODS AND SYSTEMS FOR NONLINEAR CONTROL,” each of which is hereby incorporated by reference in its entirety for all purposes.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Aspects described herein relate to computers, software, and artificial intelligence. More specifically, aspects relate to goal-oriented optimization for artificial intelligence systems.

### BACKGROUND

The field of Artificial Intelligence has attempted many approaches to the problem of replicating the capabilities of biological intelligence, but none of them have been successful to date. Additionally, the field of Neuroscience has attempted to apply many empirical approaches to dissect the operation of biological intelligence and elucidate its functioning, but to date, none of them have been successful in assembling the various empirical phenomena so discovered into a coherent understanding of how biological intelligence works.

Solving the problem of biological intelligence cannot be achieved without asking the right questions and setting the right conceptual framework, that can guide the solution using both Computer Science and Neuroscience, in the right combination, to solve the problem. From a philosophical viewpoint, the starting point for inquiry was already identified in the 1890s by William James, with his functionalist philosophy that intelligence is an evolutionary imperative that is essential for the survival of the species that have this capability. His philosophy was not an effective one, in the sense of defining what it is that intelligence is doing for their survival. Nevertheless, asking the question in this way provides a guide for the inquiry, by focusing it on the elucidation of what those survival characteristics are.

This philosophy can be made effective, by recognizing that its power is in clarifying that in biology, there is a unique and well-defined highest-level goal, i.e., survival of the species. The problem that intelligence solves, then, is that this highest-level goal, which is far removed from the low-level knowledge of the organism about the operation of the world, must be achieved, with limited capabilities for action and observation, in environments that are complex, uncertain, and novel. This clarifies that the survival advantage of intelligence is to bridge that huge gap between low-level knowledge and observations, and high-level goals, under those severe constraints, by devising complex and contingent strategies of action that optimally achieve those goals. William James' original insight is, through this thought experiment, thereby converted into an effective and fully quantitative definition of intelligence, since it translates into the known mathematical concept of a Markov Decision Process Under Uncertainty, which is studied in the field of Control Theory.

So does this precise mathematical formulation now solve the problem of intelligence? No. This mathematical problem was one of the many approaches to Artificial Intelligence proposed in the 1950s, and was studied and theoretically solved by Richard Bellman. However, because this theoretical solution is infeasible for any practical problem, this approach was long ago abandoned. To understand why, consider that the standard Markov Decision Process (without uncertainty) assumes that world states are explicitly known. Bellman's equation then finds the globally optimal action strategy by backward induction over the space of all world states, an approach which is already infeasible for many real world problems, because of the enormous number of world states. Yet on top of that, the real world also includes uncertainty, which is handled in Bellman's approach by taking the state space to be the space of all probability distributions over world states, and then performing the backward induction on that larger state space. This new probability state space is mathematically exponentially larger than the original already enormous space of world states. For most real world problems, the calculation of the optimal strategy would therefore require a significant amount of compute resources. The problem thus becomes how to solve the mathematical optimization problem in a feasible manner.

In the linear case, the Kalman Filter solves the linear control problem with uncertainty. In the linear problem, the probability distribution over world states is Gaussian, and so can be represented by a few numbers. The Kalman filter solution uses independent forward and backward induction:

Forward induction is a Ricatti equation that propagates information about the Gaussian probability distribution of world states. Backward induction is a Ricatti equation that propagates information about the rewards.

In the linear problem, these two information flows are completely independent. As indicated above, the general nonlinear control problem without uncertainty is solved by the Bellman equation. Consider state s(t) and action a(t) at time t. The optimal policy for choosing a(t) has a value function obtained by backward induction only:

$$V ( s ( t ) ) = {min}_{a ( t )} E [ C ( s ( t , a ( t ) ) + ( s ( t + 1 ) ) \vert s ( t ) , a ( t ) ] .$$

where C is the incremental cost function. As mentioned above, when there is uncertainty, as is the case, and the complete world state x is hidden from observation, the problem can be modeled in the Bellman equation by letting the state s(t) be a probability distribution over world states x. This makes the pure backward induction approach of the Bellman equation exponentially more expensive.

Due to the intractability of conventional solutions, many people have given up on finding the optimal solution and instead resorted to heuristic approaches to exploring the solution space. The general class of heuristic algorithms that is currently most popular is Deep Reinforcement Learning. This method attempts to use neural nets to help search the solution space. Unfortunately, this approach fails when novel and therefore potentially high risk phenomena are encountered, because the neural net does not generalize well outside of its training data. Such models can only learn from explicit training examples they have encountered, meaning they will be optimized for the “expected” cases to which the heuristics have guided them. That leaves such models with no way to reason about the “unexpected” cases that are inevitably encountered in real-world situations.

To take just one example, Deep Reinforcement Learning has been used as the basis for developing apparently superhuman Go-playing algorithms, which has attracted a lot of attention. But recent research has discovered that making unexpected and unusual moves against them can reduce the abilities of such algorithms to the sub-amateur level, by taking them outside of the scenarios they encountered during training.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

In order to address the above shortcomings and provide additional benefits that will be realized upon reading the disclosure, elements of the illustrative aspects described herein address new improvements to nonlinear solutions for achieving high-level goals. Artificial intelligence methods that doubly-exponentially accelerate the solution of Markov Decision Problems Under Uncertainty are provided, providing computationally feasible methods for simulating the function of intelligence in biology. Specifically, the methods described herein allow for artificial intelligence to devise optimal, contingent strategies for action in order to achieve high-level goals (such as survival), starting from low-level and potential uncertain knowledge of the world, taking into account the uncertainty about the state of the world, and limitations on the ability to take actions affecting the world state and to perform observations revealing information about the world state.

Following the algorithms described herein to come up with a computationally feasible solution to the general Markov Decision Process Under Uncertainty leads to the invention of algorithmic techniques that replicate a variety of phenomena of Neuroscience, whose relevance to intelligence was not previously understood. For example, the algorithms described herein uncover the intimate connection between intelligence and emotions, an idea incomprehensible to those who think of intelligence as a logical process. Some of these necessary inventions that replicate phenomena of Neuroscience also overturn decades of dogma in Computer Science, such as the foundations of compression algorithms. The fact that the mathematical solution helps explain previously mysterious features of Neuroscience, that have until now eluded human inventors, provides reassurance that the solution is the right one.

The methods described herein also embody true “creativity”, in that in devising the optimal strategy, an artificial intelligence considers and evaluates scenarios that may have never occurred in the past, and which would therefore never have been included in any training data relied on by traditional Artificial Intelligence methods. The methods described herein also may embody true “emotions,” which appear naturally as macroscopic statistics of the strategic optimization process. In order for memory units to be both efficient and simultaneously useful for strategic optimization, compression of observational input may be based on completely different principles from all known compression algorithms such as, for example, relying on emotions rather than the elimination of duplications. The methods described herein may also improve over conventional methods of simulating biological intelligence by allowing an artificial intelligence to embody “dreams,” in that the creation of abstractions that enable acceleration of the method via problem decomposition generally requires offline computation.

The present disclosure provides multiple improvements on conventional nonlinear methods of simulating biological intelligence, including those previously disclosed by the same inventor in: U.S. Pat. No. 10,366,325, filed Dec. 2, 2015, and entitled “Sparse Neural Control,” which is a continuation-in-part of U.S. Pat. No. 9,235,809, filed Jan. 13, 2015 and entitled “Particle Methods for Nonlinear Control, which is a continuation of U.S. Pat. No. 8,965,834, filed Nov. 20, 2012 and entitled “Particle Methods for Nonlinear Control”, each of which is hereby incorporated by reference in its entirety, through techniques such as:
dimensional reduction, to provide an additional exponential reduction in computation cost, in addition to the original exponential reduction in computational cost provided by the previous disclosures, thereby enabling the algorithm to be applied to high-dimensional real world problems;
diverse statistical objectives based on the optimized distribution of costs, that go beyond the expected cost optimization of classical control theory, in order to account for risk, and not just the optimize for the average case;
a different and more economical relationship between Artificial Intelligence and data, that does not rely on assembling any training data in advance; instead, data is acquired through observation, as a natural and integral aspect of the overall strategic optimization, taking into account the full cost, time, and value of acquiring any particular piece of data;
optimal compression of the observational history into memories, based on emotions rather than the traditional methods based on elimination of duplication, since the importance of a particular observation is not determined by novelty, but by its strategic relevance, which may be unrelated to its novelty;
multi-valued functions, to account for the possibility that there may be distinct ways of ending up at the same world state in the future, and it may be necessary to consider each of those possibilities in order to achieve the true optimal solution;
multi-scale algorithms, to provide fine levels of detail in space and time for the optimal strategy, without thereby exploding the number of particles that need to be considered at any stage of the computation;
the ability to perform abstraction, by means of problem decomposition, providing a way to save the solution of common sub-problems representing abstract concepts, in order having to re-solve them every time as part of solving more complex problems. Due to the computational requirements for the required historical re-analysis, this requires offline processing, which corresponds to the biological function of dreaming;
world model parameterization, to provide a way to handle incomplete knowledge of the world mechanics that the algorithm requires for its operation, naturally within the algorithm itself;
oracle bootstrapping, to provide a general-purpose method for initializing the forward and backward induction, especially for complex and high-dimensional problems.

The various aspects of the illustrative embodiments are substantially shown in and/or described in connection with at least one of the following figures, as set forth more completely in the claims.

These and other advantages, aspects, and novel features of the present disclosure, as well as details of illustrated embodiments, thereof, will be more fully understood from the following description and drawings.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 depicts an illustrative network environment that may be utilized in accordance with various embodiments;

FIG. 2 illustrates an example user device that may be used in a network environment, such as either a client device or a server in the network environment of FIG. 1, in accordance with illustrative aspects described herein;

FIG. 3 illustrates a general view of interactions between a user device and a computational device during iterations of the method according to illustrative aspects described herein;

FIG. 4 illustrates an overview of steps of a doubly-exponentially accelerated particle method according to illustrative aspects described herein;

FIG. 5 illustrates steps of accelerating particle methods using representations of emotions according to illustrative aspects described herein;

FIG. 6 illustrates steps of accelerating particle methods using dimensional reduction according to illustrative aspects described herein;

FIG. 7 illustrates steps of accelerating particle methods using multi-scaling methods according to illustrative aspects described herein;

FIG. 8 illustrates steps of accelerating particle methods using abstraction through problem decomposition according to illustrative aspects described herein; and

FIG. 9 illustrates an example problem to be solved using a doubly-exponentially accelerated particle method according to illustrative aspects described herein.

### DETAILED DESCRIPTION

### I. Description of Foundational Algorithm

### 1. Improved Method for Solving Markov Decision Processes Under Uncertainty

To devise an improved version of the previously disclosed method, the formulation of the solution of the intelligence problem will be re-derived as a process on the exponentially smaller world state space x, instead of the space of probability distributions over world states. This re-derivation will reveal additional opportunities for optimization of the solution.

Assume deterministic world mechanics:

$$x ( t + 1 ) = A ( x ( t ) , a ( t ) ) \\ y ( t + 1 ) = M ( x ( t + 1 ) ) = B ( x ( t ) , a ( t ) )$$

where M(x) is a measurement function providing the observable state y. To define the goal, there is also a cost function C(y(t),a(t)) that can only depend on the observable state.

Consider first a forward induction on the state s(t), which is a probability distribution over world states x, evolving according to the world mechanics followed by conditioning on the new observation:

$$s ( t + 1 ) = x \to {A ( x , a ( t ) )}_{*} s ( t ) \vert y ( t + 1 )$$

To formulate the problem the history of observed information will be required:

$$i ( t ) = y ( 0 ) … y ( t ) .$$

The policy for choosing a(t) may depend on already observed information, thus we have:

$$a ( t ) = a ( i ( t ) ) .$$

In terms of this policy, the lifted dynamics can be defined by:

$$( x ( t + 1 ) , i ( t + 1 ) ) = D [ a ] ( x ( t ) , i ( t ) ) = ( A ( x ( t ) , a ( i ( t ) ) ) , ( i ( t ) , N ( x ( t ) , a ( i ( t ) ) ) ) ) .$$

The lifted dynamics give an uninformed probability distribution p(t)(x,i) with p(0)=s(0) and:

$$p ( t + 1 ) = {D [ a ]}_{*} p ( t )$$

which breaks up into the informed state distributions when conditioned on the information:

$$s ( t ) = p ( t ) \vert i ( t ) .$$

The above equation for p(t+1) provides a forward induction on the probability information about the hidden state, which is local in x, but may need to be multi-valued in case distinct informations i have non-zero probability for the same x. It is important to note that this forward induction depends on knowledge of the policy a(i). In this nonlinear setting, the basis for choosing the policy will come from a complementary backward induction, described next, which is coupled to the forward induction through the policy a(i). This is contrasted to the linear case, where the forward and backward inductions of the Kalman Filter are uncoupled.

Even at this step, the fundamental reason for the exponential acceleration of the resulting method over the Bellman equation is already apparent. The key is that this formulation only considers the small number of probability distributions s(t) that are relevant to the optimization, instead of the entire infinite-dimensional space of all possible probability distributions over world states.

Next, the complementary backward induction will be formulated. The approach is to test whether it is possible to use a formulation in which there is a possibly multi-valued local value function v(t)(x,i) of x, such that the original value function is its expectation:

$$V ( s ( t ) ) = {E}_{s ( t )} [ x \to v ( t ) ( x , i ( t ) ) ] = {E}_{p ( t )} [ v ( t ) \vert i ( t ) ] .$$

Plugging this into the global backward induction for the value function yields an equation (e.g., a local self-consistency equation):

$${E}_{p ( t )} [ v ( t ) , ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] .$$

This equation can indeed be satisfied by the (possibly multi-valued) local equation

$$v ( t ) ( x , i ) = C ( y , a ( i ) ) + v ( t + 1 ) ( A ( x , a ( i ) ) , B ( x , a ( i ) ) )$$

which may be abbreviated as

$$- {v}_{t} = C + {v}_{x} A ,$$

thereby validating the original hypothesis about formulating the value function in terms of a local value function on the world state space.

Note that this backward induction also depends on the policy a(i) via A and C. This emphasizes again that, unlike the Kalman Filter in the linear case, in this fully nonlinear case, the forward and backward induction are now coupled by the policy a(i). During the coupled forward and backward inductions, the policy is updated in terms of p and v with an equation (e.g., an optimization equation):

$$0 = {C}_{a} + {E}_{p ( t )} [ {v}_{x} {A}_{a} \vert i ( t ) ]$$

$$or$$

$$a = {C}_{a}^{- 1} ( - {E}_{p ( t )} [ {v}_{x} {A}_{a} \vert i ( t ) ] ) .$$

The whole solution is then an iterative process, alternating between the backward and forward inductions, and the optimizations. Stability of the solution of this method, via numerical computations implemented on a computing device requires that the numerical time step Δt be controlled. To avoid characteristics crossing each other within the time step, we must have (∇·a)(Δt)≤1. This means that the optimum time step is

$$Δ t ∼ \frac{1}{\vert ∇ \cdot a \vert} .$$

This version of the method improves on the previously patented method (as cited above) by allowing multi-valued functions, due to the fact that there may be distinct paths i that end up at the same world state x at some point in the future, and it may be necessary to consider each of them in order to compute the true optimal solution. As shown above, this can create multiple layers of the functions. To derive the previous version of the method, we can collapse the multiple layers by, at each x, choosing only the most likely information i, which in many cases is a good approximation.

### 2. Improved Objectives

Although the above formulation poses the goal of the problem as optimizing the expected total cost, many other statistics of the distribution of costs may be optimized by the same method, or minor variations of it, some of which will be detailed here, and others that by extension will be apparent to those skilled in the art. Applying the expected cost objective, especially in a business setting, as has been done for decades in classical control theory, can be dangerous because it only optimizes for average outcomes and ignores the risk of business failure.

Although this problem has been recognized, the common method of trying to fix the problem is to artificially inflate the cost of bad outcomes through ad hoc adjustments. This approach creates more problems than it solves. First, the resulting statistics are meaningless. If the original costs for the business were measured in dollars, the expectation of the artificially inflated cost has no practical meaning and is not measured in dollars or any other meaningful units. Second, this approach is strategically unsound, because the artificial inflation of costs is ad hoc and cannot be compared between different business scenarios.

Instead, a better approach is to use the above method to optimize a statistical objective of the true cost that takes risks into account. There are a variety of such choices. For example, instead of expected cost, the method can optimize worst-case cost; this is done by replacing the expectation with the maximum in the above method. For business applications, this is a very conservative approach, in many cases too conservative, as it can paralyze the normal operation of the business for constant fear of a worst-case outcome.

As another example, any percentile of the distribution of costs may be optimized, by calculating both the expectation and the variance of the cost, and using those to estimate the cost at a specified percentile of the cost distribution. The variance of the cost requires one simple auxiliary calculation during the backward induction. First, the expectation 12 of total cost squared can be computed by a similar backward induction:

$$- {( {v}_{2} )}_{t} = 2 Cv + {( {v}_{2} )}_{x} A$$

and then the variance of cost is obtained as

$${v}_{2} ( 0 ) - {v}^{2} ( 0 ) .$$

Alternatively, instead of using only moments of the distribution, as just described, in applications where the shape of the distribution of future costs is far from normal, the full distribution of future costs can be calculated during the backward induction, optionally with very low probability outcomes discarded to maintain the efficiency of the method. For business applications, this percentile objective provides a better balance between accounting for the risks of business failure and achieving the best results during normal operation of the business. The percentile can be chosen to account for the business's risk tolerance, with percentiles closer to 50% for those with high risk tolerance, and percentiles closer to 100% for those with low risk tolerance. The resulting percentile statistic is also still meaningful, as it is still measured in dollars when the cost is in dollars, and reports to the business the expected cost in designedly unfavorable scenarios, with the degree of unfavourability of the scenarios controlled by the choice of percentile.

Once arbitrary statistics of the distribution of costs are considered as optimization objectives, the cost itself need no longer be observable or deterministic, as was assumed in the derivation of the method above. In both the “local self-consistency equation” and the “optimization equation”, instead of the current cost being a deterministic number outside of the statistic being optimized (there, the expectation), the unknown current cost can be added to the unknown future cost inside the calculation of the statistic being optimized, with the entire method otherwise unchanged in all respects.

The different statistical objectives can be illustrated with a real world industrial example, showing how they affect the optimal strategy and the resulting outcomes. The I-BiDaaS open source dataset includes both MES and SCADA level data for the welding station in a real but anonymous auto manufacturing plant. The two datasets are not synchronized as advertised, so the focus of this example will be on the MES data which does present an interesting strategic problem by itself. Its key characteristics are:
The time to manufacture a vehicle depends on the model being manufactured (by a factor of 5×). The models that take longer to manufacture also have more variable manufacturing time with bigger outliers (by a factor of 20×), and fewer total orders (by a factor of 130×). External sources suggest that profit margins for vehicles can vary by a factor of 20× based on the model, with rarer models able to capture higher profits (with margins ranging from 1% to 20%). To formulate a strategic problem, in accordance with this external information, the profit will be assumed proportional to the −0.6 power of the average number of orders.
The gap time between vehicles in the station does not depend much on the model or whether the line is switching from one model to a different one. In fact, the gap times don't vary much at all, with the one very important exception, that there are some very extreme outliers, some of them 200× as big as the typical gap. To formulate a strategic problem, these extreme outliers will be assumed to be due to mechanical breakdowns on the manufacturing line, uncorrelated with the models being manufactured.
The maximum number of vehicles of each model that can be produced for profit is constrained by customer orders. However, the choice of which models to produce in what order, up to that maximum, is open to the factory manager. The problem for the algorithm is to create an optimal strategy for the choice of vehicles to produce in what order, contingent on outcomes of previous choices and on unexpected occurrence of events like mechanical breakdowns.

Together, the above observations formulate a strategic optimization problem for a real auto manufacturing plant based on the open source I-BiDaaS dataset. However, the results and their usefulness depend on the chosen statistic to be optimized:
Expected Profit: In this naive formulation, the algorithm would make the obvious recommendation to produce as many of the expensive models as possible, since they are on average 4× as profitable per unit of manufacturing time. Mechanical breakdowns do not affect the strategy since they are independent of choices.
Worst-Case Profit: The factory must fund its operations from profits, or risk being shut down by creditors. In a conservative view, the objective would be to optimize the worst-case profit, so that the minimal amount of money can be raised from investors to 100% guarantee that the factory will never be shut down. In this case, the algorithm would produce a different strategy: start by producing models with the greatest worst-case profit per unit of manufacturing time, and then as time allows, continue producing models with lesser worst-case profit per unit time. Mechanical breakdowns must be included in the worst-case scenario, but again would not affect the strategy because there is no benefit for worst-case outcome from changing the strategy after such a breakdown.
Percentile Profit: Between these extremes, a more realistic and interesting objective is to choose a non-zero, but sufficiently small and acceptable risk of the factory being shut down, and optimize the money that must be raised from investors to cover profit shortfalls to achieve that risk. This probability is used to choose a percentile of the cost as the objective to optimize In this case, the algorithm would produce a more interesting and less obvious strategy: in the event of mechanical breakdown, the recommendation would be to switch to gambling on producing models with higher average profit per unit of manufacturing time, to create non-zero probability of making up the large loss produced by the breakdown, which cheaper models with more reliable profits have no hope of accomplishing.

### 3. World Mechanics

Although the above formulation is in terms of deterministic world mechanics, one skilled in the art can extend the method to the case of stochastic world mechanics by applying the methods used for that same purpose in the previously patented method, as cited above. Also, although the above formulation is in terms of continuous world mechanics, one skilled in the art can extend the method to the case of discrete world state spaces by applying the methods used for that same purpose in the previously patented method, as cited above.

The exact world mechanics may not be known at the beginning. This kind of situation can be handled by the same method, by using a model of world mechanics that contains unknown parameters, and including those unknown parameters into the world state. The initial uncertainty about the value of those parameters is then included in the initial uncertainty p(0) along with all the other uncertainties, and observational information i(t) acquired through time then provides increasingly more precise knowledge of those world model parameters.

### 4. World State Geometry

The above method does not specify the geometry of the space of world states, because it applies to any world state space geometry. There may be good reasons to apply a non-Euclidean geometry to the world state space because, for practical applications to complex business processes, even if the world state is specified as a vector of numbers, the notion of when two world states are “close together” may have nothing to do with the standard notion of Euclidean distance between those vectors. For example, if part of the world state represents a permutation or ordering, the Euclidean distance between them is meaningless; instead, a distance measure based on the number of relative inversions between the two permutations provides a more meaningful notion of closeness.

### 5. Strategic Approach to Data

As can be seen from the above derivation, the above method does not depend on any training data at all. Where does the information necessary to make decisions then come from? Upon closer inspection of the method, what becomes apparent is that data is instead acquired strategically, as an integral part of the overall optimal strategy produced by the method, taking into account the full time, cost, and benefit of acquiring any particular piece of data. This is because the optimal strategy produced by the method prescribes optimal actions, taking into account all costs, which can either directly or indirectly result in the revealing of additional observational data, which is then recorded in the history of observational information i(t), and made available for the benefit of current or future decisions about optimal actions a(i).

This is the opposite of the approach taken by traditional artificial intelligence, which assumes that massive training data sets can and should be assembled in advance at low cost. Despite the massive size of some of these training data sets, the resulting artificial intelligence models are still limited to learning only what has been selected for inclusion into this training data in advance. They are therefore unable to handle novel situations which were not anticipated by the assemblers of these training data sets.

### 6. Particle Methods

For complex strategic optimization problems, an efficient method of applying the above improved control method is to use a particle method. Each particle holds the data (x, p, i, a, v), using the notation of the algorithm derivation above. The above improved method governs the independent evolution of each particle, without reference to other particles. This allows the method to be accelerated by many orders of magnitude through the use of massively parallel hardware. For example, GPUs and GPU clusters can have 4-7 orders of magnitude of parallelism.

There is however one particle interaction term introduced by the optimization of the action a, which requires knowledge of the derivative vₓ. This must be calculated by looking at the v values of nearby particles. There are known data structures for more efficiently identifying exact or approximate nearest neighbors of points in a given point set, which can be used to identify nearby particles for the calculation of vₓ.

There are further opportunities for acceleration, described below, which are best understood by looking at a concrete example. To provide a basis for understanding these further accelerations, the method will first be applied as described above, to this example. The example problem will be the task for a robot to get coffee for a person.

The robot knows nothing about how to achieve this task. It is just put into a situation where there is, for example, a coffee cup, two coffee pots, only one of which has coffee, but it is unknown which one, and a person who wants the coffee. It is not given to the robot that the coffee cup is necessary to transport the coffee from the coffee pots to the person; or that it must find the coffee pots to obtain the coffee necessary to achieving the goal. It must discover all that itself from the world mechanics that effectively allow the coffee cup to carry coffee from one place to another if held properly and the ability of the coffee pots to dispense coffee.

Note that this problem involves uncertainty since we do not know which coffee pot holds the coffee. The robot must devise an optimal strategy that includes branching decisions when it discovers that a particular coffee pot does or does not have any coffee. Because this problem involves uncertainty, both the backward and forward induction of the above method are necessary.

The above method automatically discovers the complex, branching strategy that the robot has to first retrieve the coffee cup as a tool, then go to a first coffee pot to check for coffee, then make a decision based on presence of coffee there to either carry the coffee from there without spilling to the person, or if empty, to backtrack to a second coffee pot to get the coffee from there and then transport it with the coffee cup without spilling back to the person. More concretely, the particle method as described above, without further accelerations, implemented in Python, achieves this solution in 20 seconds on a 2-core machine with 512 particles.

### 7. Additional Acceleration of Memory via Emotions

As an emergent phenomenon, emotions can be ascribed to the artificial intelligence implemented by the above method. These emotions emerge as the macroscopic statistics of the detailed optimal solution to the control problem, and can be computed with no or minimal additional effort. For example, tension has to do with the variance of the outcomes despite optimal actions, which can be calculated as part of the method using the auxiliary calculation for cost variance explained above. The fear emotion is based on tension with expectation of a negative outcome (another macroscopic statistic). One skilled in the art can extend this method to compute a variety of other emotions, such as happiness and anger, by applying the methods used for that same purpose in the previously disclosed methods.

These emotions are not a mere curiosity, but turn out to be an essential aspect of accelerating the above method to make it feasible for application to complex problems. The reason is that the variable i(t), representing the history of observational information, can quickly accumulate to impractical size in its raw form, which is analogous to “photographic memory”. This variable should therefore be stored and used by the algorithm in a compressed form, filtering the full, raw, continuous flow of observations down to discrete “memories” that have the highest relevance to solving the overall optimization problem. This relevance to the solution is mathematically determined by the statistics of future outcomes, using a fully optimized forward strategy, at the time of the observation. As just explained, these statistics correspond to the biological phenomenon of emotions. Thus, the above method can be accelerated by compressing the raw observational history into discrete memories based on emotions, as calculated above.

This is different from the reigning dogma of compression algorithm design, which is based on elimination of duplications, i.e., on the novelty of a particular observation. However, simple novelty may not confer any strategic value to an observation, and so storing it in memory just because of its novelty will waste a lot of space. The strategic value of any observation can only be determined by the statistics represented by emotions.

As an independent confirmation of this approach to compression, biological intelligence, which serves to optimize the survival and reproduction of the organism, is similarly based on compression of raw observations into a “memory” subsystem, and it is a long-established fact of neuroscience that the strength of such biological memories is primarily driven by the emotional content of the experiences.

### 8. Additional Exponential Acceleration in High Dimensions via Dimensional Reduction

One type of acceleration that can be applied to the present method is to use dimensional reduction. Many practical problems could contain a very large number of nominal dimensions (possibly millions in complex industrial applications), and in such cases, this acceleration will provide a further exponential reduction in computational effort beyond the exponential reduction already provided by the method of the previous patents, as cited above.

A specific method is devised to apply dimensional reduction to accelerate methods described herein, and a concrete demonstration is provided for the above example problem. The method to accomplish this is to reduce the dimensions in the computation selectively and dynamically to only those that are relevant to decision making at any moment in time and any state of the world during the forward or backward induction. Dimensions representing world state that is far away or unobservable need not be considered. Even though many practical problems could contain a very large number of nominal dimensions, most of them are typically not relevant to decision making at any particular moment. As a result, this can accelerate the solution.

In the above example problem, in particular, we don't need to consider the actual location of the coffee as part of the world state before we discover that location; any prior decision must be made without knowledge of that location. This reduces the problem to two dimensions for that part of the computation, and requires only 126 particles to solve the problem. This will turn out to be the best out of all of the acceleration methods considered here, in terms of particle count. The Python code implementing this method runs in 12 seconds on a 2-core machine.

### 9. Additional Acceleration of Fine-Grained Control via Multi-Scale Methods

A second type of acceleration that can be applied to the present method is to use a multi-scale algorithm. This is useful when the optimal strategy is desired at fine levels of detail in space and time, without this desire thereby causing an explosion in the number of particles necessary for the computation. Typical practical problems where this can be useful are similar to the coffee problem, where the solution involves fine-grained optimal actions over an extended period of time without branching, such as the robot carrying the coffee without spilling all the way from the coffee pot to the person. The robot must maintain very fine control over an extended carrying period to avoid an accidental spill, but it would be infeasible to run the entire computation at such a fine level of detail.

A specific method is devised to apply multi-scale algorithms to accelerate the methods described herein, and a concrete demonstration is provided for the above example problem. The method to accomplish this is to scale up interaction distances and speeds of motion in the world mechanics, to create a coarse version of the problem. Then finer scale particles are only interpolated in a small neighborhood of the coarse scale solution. This coarsening can be repeated at multiple scales to produce a full multi-scale solution. The final solution is then computed on the finest scale, using a much smaller number of particles than would have been required to solve the entire problem on the finest scale.

In the above example problem, the resulting coarse scale problem can be solved with just 64 particles. Interpolating to the finer scale in a neighborhood of the coarse scale solution, only 231 fine-scale particles are needed, which can then be used to solve the original problem. The total compute time on a 2-core machine using this multi-scale algorithm in Python is reduced to 8 seconds.

### 10. Additional Acceleration for Complex, Hierarchical Worlds via Dreaming

A third type of acceleration that can be applied to the present method is to create a capability for abstraction through problem decomposition. This acceleration is useful when computing optimal strategies for complex problems that involve recurring sub-problems for which it would be wasteful to recompute the portion of the full optimal strategy dealing with that sub-problem every time. Instead, a library of pre-solved sub-problems representing these abstractions can be accumulated, and re-used repeatedly to accelerate the full optimization problem.

The creation of such a library of repeated sub-problems requires the re-analysis of historical experience, that is, the current memory store i(0), far back in time, and as a result cannot be performed in real time. The offline computation necessary to create such a library is analogous to the biological phenomenon of dreaming. The need for intelligent organisms to sleep and dream has long been a puzzle in biology, since it places such organisms in vulnerable positions for extended periods of time, and must therefore provide some valuable survival advantage. That advantage is the tremendous acceleration of intelligence that can be achieved through the use of proper abstractions.

A specific method is devised to apply problem decomposition to accelerate methods presented herein, and a concrete demonstration is provided for the above example problem. Other methods for problem decomposition may be apparent to those skilled in the art. The specific method to accomplish this is to create a series of lower dimensional problems that only involve a subset of the objects in the world that might interact as part of the overall solution to the problem, setting the intermediate goal of each sub-problem to have those objects interact in some manner. Being lower dimensional, these sub-problems are faster to solve. The solutions to these sub-problems then provide candidates for a head start in solving the full problem, by potentially having achieved intermediate goals that contribute to the solution of the full problem. By having already solved a portion of the full problem, these head starts reduce the computational time to solve the full problem.

In the above example, the candidate sub-problems would have as an intermediate goal having the robot interact with an object that could serve as a tool to solve the full problem. Specifically, the intermediate goals would be to get the robot to find and interact with some other object such as a coffee pot or a coffee cup. Either one of these searches is a lower dimensional problem, so can be solved faster. Finding a coffee pot doesn't help solve the full problem if the robot hasn't found the coffee cup first, but finding a coffee cup makes it easier to solve the rest of the problem, because that is a necessary tool to retrieve the coffee from one of the coffee pots. Having solved the sub-problem of finding the coffee cup, the rest of the solution of the full problem is faster. Using this problem decomposition approach, the above example can be solved using Python code in 9 seconds on a 2-core machine.

### 11. Numerical Analysis in High Dimensions

Performing approximate numerical operations like interpolation of values and reallocation of probabilities is well-understood in low dimensions. When attempting to perform such numerical calculations in high dimensions, new phenomena occur that require careful consideration.

In high dimensions, it is not merely infeasible, but also undesirable, to perform interpolation involving all of the dimensions of the problem. First, because the number of dimensions may be impractically large; second, because the number of particles to interpolate from may be smaller than the number of dimensions; and third, because even if there were sufficiently many particles to perform a full-dimensional interpolation, due to the vastness of the high-dimensional space, it is unlikely that all of those particles would be situated in a manner as to provide relevant information for the interpolation. Turning the last point from a possibility into a certainty, when the above method is practically applied in high dimensions, by means of the dimensional reduction and other acceleration techniques described above, the particles are by design placed in a non-uniform manner in the high-dimensional space.

The correct concept for thinking about particles in a high-dimensional space is therefore the “data manifold”. This is a much lower-dimensional set along which the nearby particles are concentrated. The exact dimension of this data manifold may vary over space and time. The objective of interpolation in high dimensions should be to only interpolate continuous functions on the local data manifold. When considering potential nearest-neighbor particles from which to interpolate, it is possible to automatically detect when one is leaving the local data manifold by putting the neighboring particles in distance order, and noting when the interpolation weights drop by a sufficiently large factor as to indicate that one has stepped off the manifold. Thus, the number of particles involved in the interpolation can be automatically and locally controlled. This basic principle of operating on the local data manifold applies to all numerical operations involved in the execution of the above method in high dimensions.

### 12. Oracle Bootstrap Method

Because the forward and backward inductions are not independent but coupled by the action policy a(i), the question arises how to initialize these inductions before either one exists. Brute force methods, considering every possible world state, can achieve this, but are infeasible for complex, high-dimensional problems.

To be more precise, the only knowledge that is available to begin the computation is the initial uncertainty p(0) about the state of the world. For any kind of forward induction, there is not yet any strategic guidance for choosing actions, in the form of the local value function v, that would have been produced by a previous backward induction. For any kind of backward induction, there is not yet any strategic guidance for choosing final world states as end points, in the form of a final uncertainty p(t), that would have been produced by a previous forward induction. Yet it is desired to choose particles that sufficiently explore the diversity of strategic outcomes, both successes and failures, to be able to compute a sufficiently comprehensive value function v on the first backward induction, and thus to guide choice of actions on the subsequent forward induction, and so on.

The simplest approach would be to start with a bootstrap forward induction that chooses random actions, preferably from the dimensionally-reduced set of possibilities provided by the methods described herein. However, in complex problems, where the strategic optimization provided by the methods described herein is necessary for any chance of success, this approach would result in close to zero likelihood of generating any successful scenarios. As a result, the value function v generated on the subsequent backward induction would provide no useful guidance for optimal action.

The solution is to start with a bootstrap forward induction based on an “oracle”. It would start with particles representing the initial uncertainty p(0) about the state of the world, but instead of using guidance from the non-existent local value function v, it would make secret use, with some chosen probability, of unobserved information about the world state, which would not normally be available to make decisions, in order to select actions with higher probability of a successful outcome of the overall problem. This has the potential to generate a set of particles through time that explore some non-zero fraction of more successful scenarios, generating a set of final states that can be used on the first, subsequent backward induction to compute an initial guess for the local value function v that both (1) includes many instances of success and failure to provide a useful guide for what to do and what not to do, and (2) doesn't waste resources on scenarios not relevant to world states represented in the initial uncertainty p(0).

13. Advantages over Existing Methods

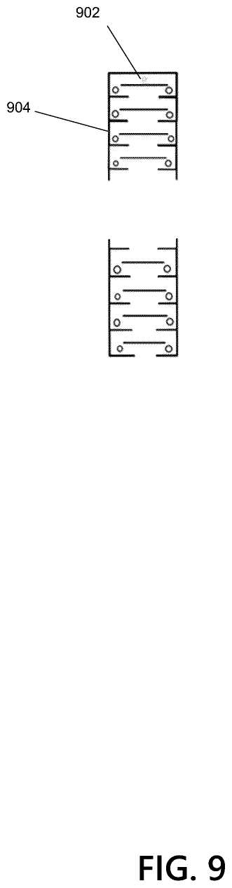

Due to the exponential acceleration inherent in the methods presented herein, the advantage over the Bellman equation can be unboundedly large. Consider, for example, the simple situation illustrated in FIG. 9. FIG. 9 illustrates an example problem to be solved using a doubly-exponentially accelerated particle method: a 20 layer maze to reach a star 902, where each layer of the maze includes one or more friendly or deadly animals represented by circles 904. The present methods provide an advantage of at least a factor of 10⁵³ in efficiency.

For example, in the situation of FIG. 9, a robot must navigate a 20-layer maze to reach the star 902 for a reward. At each level of the maze, the robot has two choices of how to move. On each of these paths there is either a friendly or deadly animal, so the robot must choose to avoid the deadly animal to reach the goal. Because of the walls of the maze, the robot cannot see what the animals are at each layer until it reaches that layer.

Thus, there are at least 2²⁰≈1,000,000 different hidden states to consider in this problem. The Bellman equation must start from the 1,000,000 different possible end states where everything has been seen, and run backward induction to arrive at initial states consisting of all possible probability distributions with 1,000,000 probabilities. Even if we discretize and allow only 10 values of the probability, we have to consider at least (1,000,000 10)≈10⁵³ probability distributions where 10 different world states each have 0.1 probability.

The methods described herein, by contrast, run both forward and backward in time over the exponentially smaller world state space. Moreover, as described above, as one method of acceleration, unknown states far away are irrelevant to the immediate decision, and can be dropped from the computation at that moment in time, but will be taken into account by the iteration over backward and forward sweeps in time of the algorithm, which will converge to a globally optimal strategy that takes all of the hidden state into account. Thus, at each point in the timeline, these methods only need to consider a small number of possibilities of what could lay immediately ahead and are relevant to optimizing the current action, a small number on order of magnitude 10°=1. Thus, the methods described herein provide at least a factor of 10⁵³ acceleration over the Bellman equation.

A quantitative comparison to heuristic methods that do not guarantee finding the optimal strategy is difficult. Such methods can be made inexpensive by lowering the probability of finding the optimal solution.

### II. Illustrative System Architecture

In the following description of the various embodiments, reference is made to the accompanying drawings, which form a part hereof, and in which is shown by way of illustration various embodiments in which the aspects described herein may be practiced. It is to be understood that other embodiments may be utilized and structural and functional modifications may be made without departing from the scope described herein. Aspects are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

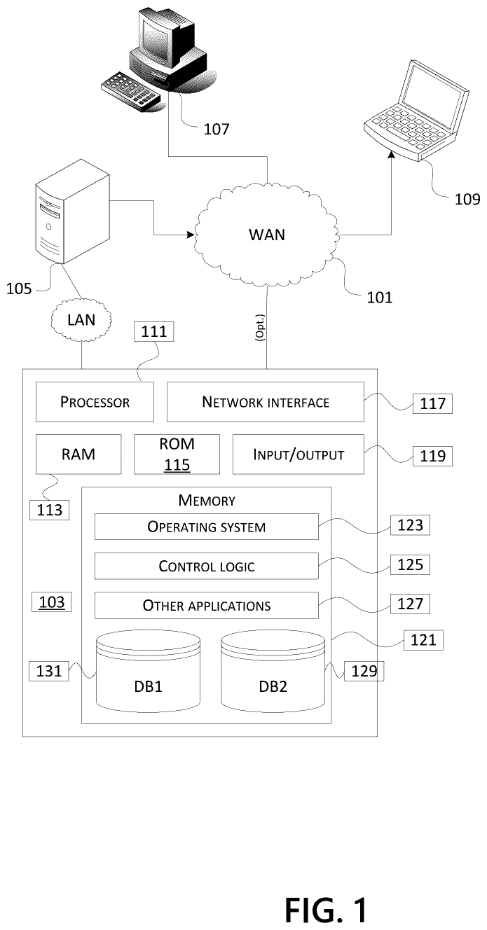

FIG. 1 illustrates one example of a network architecture and data processing device that may be used to implement one or more illustrative aspects. Various network nodes 103, 105, 107, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include computational unit 103, web server 105, and client devices 107, 109. Computational unit 103 may be a general or special-purpose computer or computer farm. Computational unit 103 may be a computational unit that provides overall access, control and administration of databases and control software for performing one or more illustrative aspects described herein. Computational unit 103 may be connected to web server 105 through which users interact with and obtain data as requested. Alternatively, computational unit 103 may act as a web server itself and be directly connected to the Internet. Computational unit 103 may be connected to web server 105 through the network 101 (e.g., the Internet), via direct or indirect connection, or via some other network. Computational unit 103 may have significant ability to run multiple instances of the described method in parallel. Computational unit 103 may also have significant bandwidth for communication of data between multiple instances of described method. Users may interact with the computational unit 103 using remote devices 107, 109, e.g., using a web browser to connect to the computational unit 103 via one or more externally exposed web sites hosted by web server 105. Devices 107, 109 may be used in concert with computational unit 103 to access data stored therein, or may be used for other purposes. For example, from device 107 a user may access web server 105 using an Internet browser, as is known in the art, or by executing a software application that communicates with web server 105 and/or computational unit 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and computational unit 103 may be combined on a single server.

Each component 103, 105, 107, 109 may be any type of known computer, server, or data processing device. Computational unit 103, e.g., may include a processor 111 controlling overall operation of the computational unit 103. Computational unit 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing computational unit 103 to perform aspects described herein, and other application software 127 providing secondary, support, and/or other functionality which may or may not be used in conjunction with aspects described herein. The control logic may also be referred to herein as the computational unit software 125. Functionality of the computational unit software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

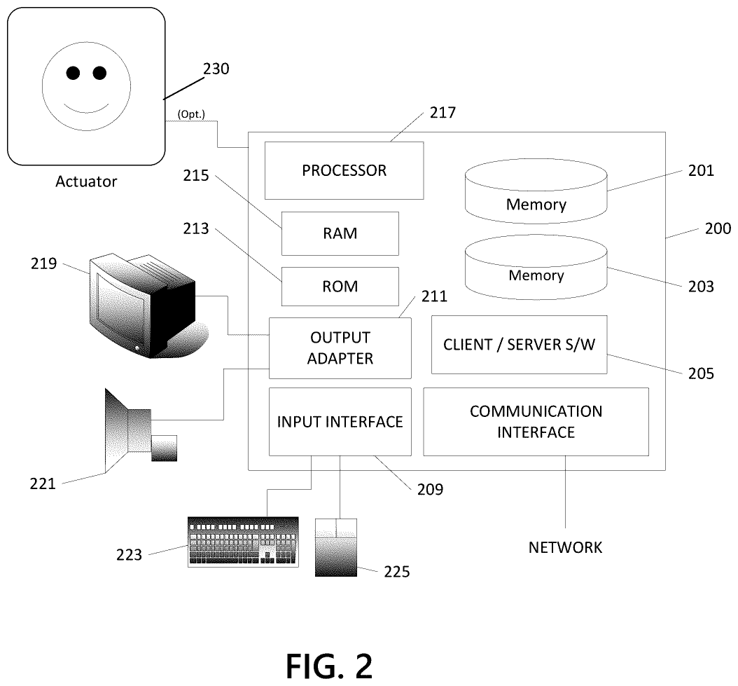

As described above, the computational unit 103 may perform methods described herein. FIG. 2 illustrates an example user device 200 such as device 107 (shown in FIG. 1) with which a user may access and communicate with computational unit 103. User device 200 and computational unit 103 may be part of the same device or may be separate devices. User device 200 may include a variety of components and modules including a processor 217, random access memory (RAM) 215, read only memory (ROM) 213, memories 201 and 203, which may include one or more collections of data, such as databases, client or server software 205, output adapter 211, input interface 209 and communication interface 207. Processor 217 may include a graphics processing unit (GPU) or a separate GPU may be included in the output adapter 211. Memory 201 may be configured to store electronic data, inclusive of any electronic information disclosed herein. Another memory, such as memory 203, may be configured to store different or overlapping data. In one embodiment, memories 201 and 203 may be a single, non-transitory computer-readable medium. Each memory 201, 203 may or may not include a database to store data or include data stored in RAM memory, accessed as needed by the client/server software. Data associated with the method described may be communicated between user device 200 and a computational unit 103 or a server through a transceiver or network interface, such as communication interface 207.

One or more statutory computer-readable mediums, such as medium 201 or 203 may be configured to contain sensor/server software (graphically shown as software 205). Sensor software 205 may, in one or more arrangements, be configured to identify observational data as well as facilitate or direct communications between two devices, including remote devices 109 and/or communications devices, among other devices. A user may control the device, through input interface 209 using various types of input devices including keyboard 223 and mouse 225. Other types of input devices may include a microphone (e.g., for voice communications over the network), joysticks, motion sensing devices, touchscreens 219 and/or combinations thereof. In one or more arrangements, music or other audio such as speech may be included as part of the user experience with the device. Further collection of observational data may be facilitated through cameras, GPS, accelerometers, chemical detectors, or any other such input structures that may aid in gathering observational data. In such instances, the audio may be outputted through speaker 221. Further, this observational data may be limited to a virtual world. In such embodiments, observational data may be produced and inputted via computers or other computational units. Such observational worlds may include, but are not limited to, video games and simulator programs. In such embodiments, observational data may contain virtual data, such as virtual chemical compositions and virtual acceleration. Such observational data may include instead or in addition to virtual sensory data, data regarding the state of a computational device which runs, compiles, or outputs such described virtual world. Data regarding the state of a computational device may include but is not limited to the amount of RAM/ROM currently being used, battery life, or the progression of a program.

In some embodiments, the actions dictated by the method described may be performed by actuators 230. These actuators 230 may comprise any structure or separate device which outputs directions to perform an action to a user or itself performs some of or all of the action dictated by the method described. Such actuators 230 may include, but are not limited to, various machines such as automobiles or computers, appliances such as alarm clocks or washing machines, and robotic or artificially intelligent entities such as automated personal assistants. Such actuators 230 may be physically a part of user device 200 or computational unit (such as 103 shown in FIG. 1). Actuators 230 may also interact with user device 200 or computational unit 103 through a network (such as 101 shown in FIG. 1). Actuator 230 may provide instructions and possible outcomes of directed actions to a user through an output device. Actuator 230 may also express emotions to the user indicating how a course of action may emotionally affect the user. Such emotion may be expressed through facial structure of a virtual face or through the tone of a virtual voice providing instructions to the user. Actuator 230 also may be used to perform specific tasks in order to achieve a goal which may be inputted into the method described. In a real-world setting, actuator 230 may perform any of a myriad of tasks including but not limited to decelerating a vehicle if its driver is emotionally distraught, closing the windows of a dwelling if a new pet seems particularly adventuresome, or collecting a user's favorite foods before a user is hungry in order to avoid traffic later. In a virtual setting, actuators 230, may perform any actions that an actuator may in a real-world setting. Also, an actuator 230 may be a virtual character in a game or simulation which performs actions or expresses emotion dictated by the method described.

Software 205, computer executable instructions, and other data used by processor 217 and other components of user device 200 may be stored in memories, 201, 203, RAM 215, ROM 213 or a combination thereof. Other types of memory may also be used, including both volatile and nonvolatile memory. Software 205 may be stored within RAM 215, ROM 213 and/or memories 201 and 203 to provide instructions to processor 217 such that when the instructions are executed, processor 217, device 200 and/or other components thereof are caused to perform functions and methods described herein. In one example, instructions for generating a user interface for interfacing with a server 105 or user device 107 may be stored in RAM 215, ROM 213 and/or databases 201 and 203. Software 205 may include both applications and operating system software, and may include code segments, instructions, applets, pre-compiled code, compiled code, computer programs, program modules, engines, program logic, and combinations thereof. Computer executable instructions and data may further be stored on some physical form of computer readable storage media (referred to herein as “computer memory”) including, e.g., electrically erasable programmable read-only memory (EEPROM), flash memory or other memory technology, CD-ROM, DVD or other optical disk storage, magnetic cassettes, magnetic tape, magnetic storage and the like. Software 205 may operate to accept and process observational data so that it may be used by the method described. There may also be software 205 that relays actions dictated by the method to the user. In some cases such software 205 may produce a text or voice list of instructions. Also, software 205 may allow an actuator to perform an action dictated by the method.

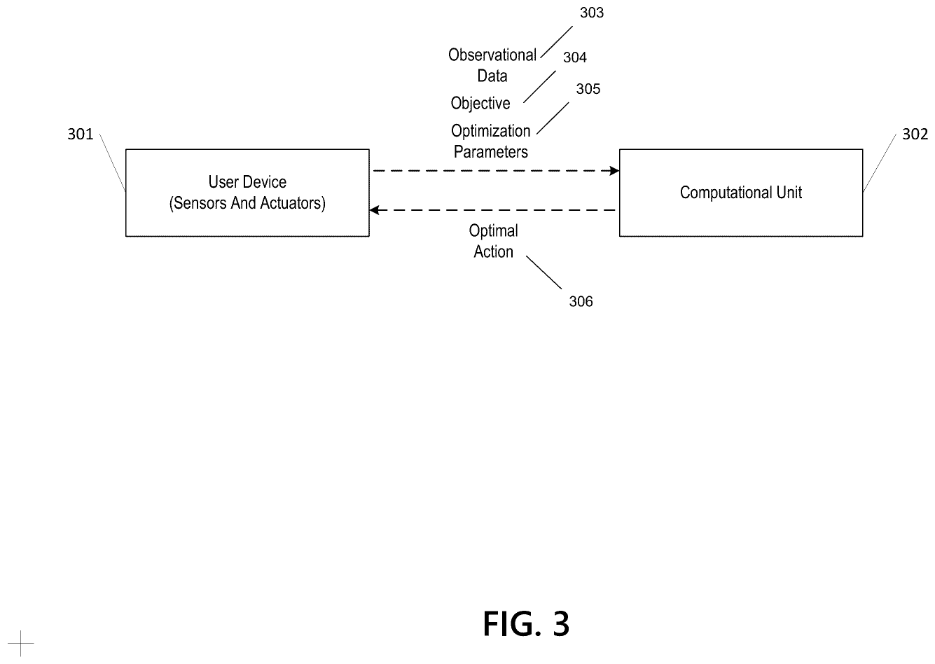

FIG. 3 shows a general view of possible communication between a user device 301 and the computational unit 302 which performs the method described. In some examples, the computational unit 302 may be configured to support the calculation of multi-valued functions. In the shown embodiment, the user device 301 contains the input structures as well as the actuators. As described above, however, such a user device 301 need not contain all those elements. As shown in FIG. 3, the user device 301 may relay information to the computational unit 302. For example, the user device 301 may send, transmit, and/or otherwise relay information such as observational data 303 (e.g., information captured by a sensor such as a camera, thermometer, barometer, potentiometer, microphone, and/or any other type of sensor, information provided by a computing device (e.g., a mobile phone, a laptop, a server, or the like), and/or other observational data), an objective 304 (e.g., a goal to be achieved and/or a problem to be solved by simulating biological intelligence), optimization parameters 305 (e.g., a world state geometry, a real or simulated world state, an optimal number of dimensions for determining how to achieve an objective, an optimal scale for determining how to achieve an objective, and/or other parameters), and/or other information, to the computational unit 302.

In some examples, a user may input an objective 304 to be achieved into the user device to be relayed to the computational unit 302. Additionally and/or alternatively, in some examples, the objective 304 may be determined based on observational data 303. Such an objective 304 may be a high-level goal, such as survival. Additionally and/or alternatively, in some examples, the objective 304 may be and/or comprise one or more high-level goals corresponding to another high-level goal. For example, the objective 304 may be and/or comprise avoiding hunger while simultaneously not gaining weight, not wasting any food, and/or not spending over $300 a month on food, each of which may correspond to the high-level goal of survival. The described observational data 303 and objective 304 may be communicated to the computational unit 302 through any of various methods of communication exemplified in the above description of FIG. 1. Using that observational data 303 and objective 304, the computational unit 302 performs the described doubly-exponentially accelerated particle methods in order to determine optimal actions 306 to achieve objective 304. For example, the computational unit 302 may determine one or more steps to take, choices to make, contingent strategies to implement, and/or other optimal actions to be performed by a robot and/or a human to achieve the objective 304. In some examples, the computational unit 302 may determine the optimal actions 306 based on applying one or more optimization parameters 305 to the methods described herein. Such optimal actions 306 may be outputted to an actuator, here associated with the user device, 301. The actuator may then display instructions according to the optimal actions 306, cause one or more devices, actuators, or the like to perform the optimal actions 306, and/or perform the optimal actions itself.

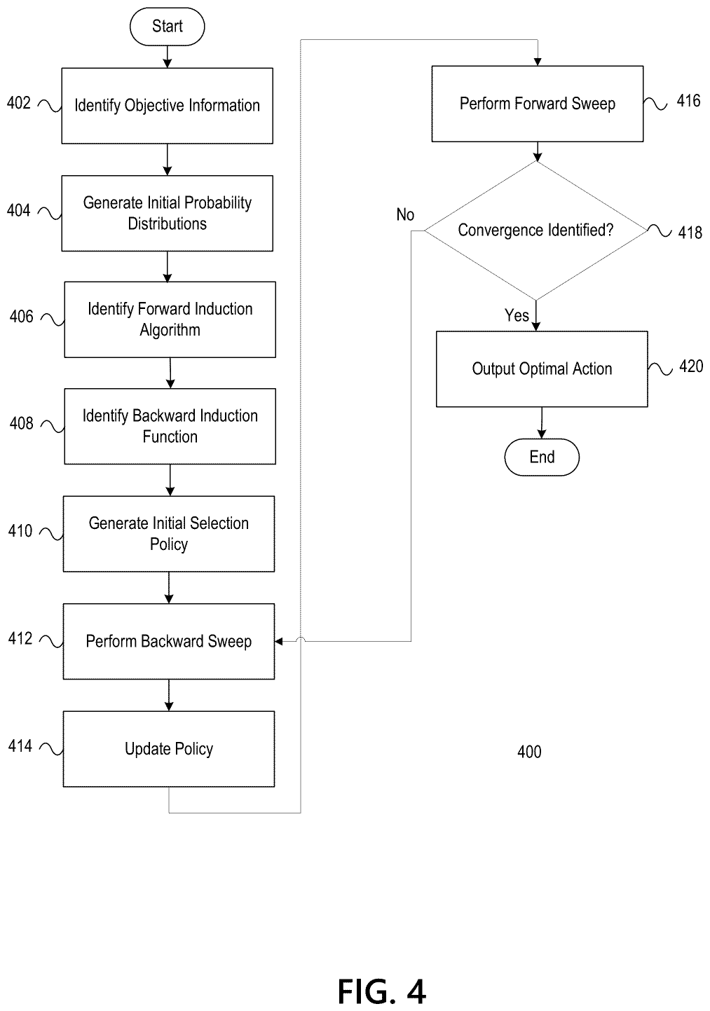

The computational unit 302 may perform doubly-exponentially accelerated particle methods as described herein. FIG. 4 provides a general overview of steps of a doubly-exponentially accelerated particle method 400. Referring to FIG. 4, at step 402, a doubly-exponentially accelerated particle method may begin by identifying objective information. In some examples, the computational unit may identify objective information by receiving the objective information from a user device (e.g., user device 301, or the like), one or more sensors (e.g., thermometers, barometers, cameras, potentiometers, microphones, or the like), and/or other sources. The objective information may comprise a high-level goal, as described above. In some examples, the objective information may correspond to a real or simulated world state. For example, the objective information may correspond to a world state with deterministic world mechanics. Also or alternatively, in some examples, the objective information may comprise instructions to restrict numerical calculations performed by the computational unit to a local data manifold within a full-dimensional space of states. Also or alternatively, the objective information may correspond to a world state with to stochastic world mechanics. In some examples, the objective information may correspond to a world state with unknown mechanics and/or parameters. The real or simulated world state may comprise either of a Euclidean geometry or a non-Euclidean geometry without departing from the scope of this disclosure.

The computational unit may, based on or as part of receiving and/or identifying the objective information, maintain the objective (e.g., by storing an indicator of the objective to a memory unit of the computational unit, and/or by other means). In maintaining the objective, the computational unit may also or alternatively maintain a current uncertainty about an unknown state of the world corresponding to the objective. The current uncertainty may be periodically updated using data acquired by the computational unit (e.g., via one or more sensors, and/or by other methods). Maintaining the objective may comprise representing the objective using an incremental cost of a plurality of potential actions.

In some examples, in identifying the objective information, the computational unit may additionally or alternatively formulate a multiplicity of particles. The particles may be and/or comprise data structure comprising scalar and/or vector variables such as time, an unknown state of the world, current observational information, historical observational information, expected future costs, unnormalized probabilities representing the state of the world, and/or other variables. For example, the computational unit may, as described herein, identify the objective information by defining an objective by determining an initial particle distribution based on the following variables and/or functions corresponding to variables, assuming deterministic world mechanics as described above:
t time.
x a vector representing an unknown state of a real or simulated world, as described herein
y a vector representing an observable state
M(x) a measurement function corresponding to the vector y, and/or
C(y(t),a(t)) a cost function corresponding to the observable state

The initial particle distribution may correspond to (e.g., comprise, represent, and/or otherwise be associated with) information of an unknown state of a real or simulated world, information of an uninformed probability distribution, information of one or more historical observable states, an indication of a selection policy, a value function corresponding to the objective, an expectation of the value function, and/or any other information, functions, or the like used to perform particle methods as described herein.

At step 404, the computational unit may generate one or more initial probability distributions which may, for example, correspond to the real or simulated world state. The computational unit may generate the one or more initial probability distributions based on the objective. For example, as described above, the computational unit may generate initial probability distributions over a particular world state space x representing an unknown state of a real or simulated world, rather than the space of probability distributions over all world states.

In some examples, as part of and/or based on generating initial probability distributions for performing doubly-exponentially accelerated particle methods, the computational unit may initiate an oracle bootstrap method as described herein. For example, based on a multiplicity of particles (which may, e.g., be generated and/or identified at step 402), the computational unit may represent an initial probability distribution p(0) of an uncertainty of the state of the world.

At step 406, the computational unit may identify a forward induction algorithm. In some examples, the computational unit may receive the forward induction from a user. Additionally and/or alternatively, in some examples, the computational unit may derive the forward induction through one or more methods described herein. For example, the computational unit may derive the forward induction algorithm as a process on a world state space x, instead of the exponentially larger space of probability distributions over all world states, as described herein.

In identifying the forward induction algorithm, the computational unit may determine a vector and/or sequence of vectors i(t) representing one or more historical observable states and/or historical observed information:

$$i ( t ) = y ( 0 ) ... y ( t ) .$$

In some examples, the computational unit may additionally determine lifted dynamics of a selection policy (e.g., a selection policy for determinizing optimal actions to achieve an objective with an optimized chosen statistic of an expected total future cost, as described herein). The selection policy may depend on already-observed information (e.g., as described at step 410). In some examples, the lifted dynamics D[a] may be defined by:

$$( x ( t + 1 ) , i ( t + 1 ) ) = D [ a ] ( x ( t ) , i ( t ) ) = ( A ( x ( t ) , a ( i ( t ) ) ) , ( i ( t ) , B ( x ( t ) , a ( i ( t ) ) ) ) ) .$$

In identifying the forward induction algorithm the computational unit may further determine an uninformed probability distribution p(t)(x,i) with p(0)=s(0). The uninformed probability distribution may be determined based on the lifted dynamics of the selection policy. For example, the uninformed probability distribution may have:

$$p ( t + 1 ) = {D [ a ]}_{*} p ( t )$$

The uninformed probability distribution may break up into informed state distributions when conditioned on the information:

$$s ( t ) = p ( t ) \vert i ( t ) .$$

In this way, the uninformed distribution may correspond to the one or more initial probability distributions described herein. The computational unit may derive the forward induction algorithm based on performing the steps described above to come to the uninformed probability distribution. The forward induction algorithm may be largely local in the vector x. In some examples, the forward induction algorithm may additionally or alternatively be multi-valued.

In some examples, prior to identifying the forward induction algorithm or after identifying the forward induction algorithm but prior to using the forward induction algorithm, the computational unit may bootstrap and/or otherwise initialize the forward induction with an initial oracle-based forward induction. For example, as described herein, the computational unit may begin with particles representing the initial probability distribution p(0) of an uncertainty of the state of the world and, with some chosen probability, use an initial forward induction algorithm to generate a set of particles through time. The initial oracle-based forward induction may choose actions based on unobserved information about the real or simulated world state to determine a level of success corresponding to the performance of different actions. The set of particles may explore some non-zero fraction of successful scenarios, generating a set of final states that may, in some examples, be used in performing a coupled induction loop as described herein.

At step 408, the computational unit may identify a backward induction function. In some examples, the computational unit may receive the backward induction function from a user. Additionally and/or alternatively, in some examples, the computational unit may derive the backward induction function through one or more methods described herein. For example, the computational unit may derive the backward induction function complementary to the forward induction algorithm of step 406 by formulation a local value function v(t)(x,i) of x, such that the original value function is its expectation, as described herein:

$$V ( s ( t ) ) = {E}_{s ( t )} [ x \to v ( t ) ( x , i ( t ) ) ] = {E}_{p ( t )} [ v ( t ) \vert i ( t ) ] .$$

In identifying the backward induction function, the computational unit input the local value function into a global backward induction to yield the expectation Eₚ₍ₜ₎[v(t)(x,i)|i(t)]:

$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] .$$

The computational unit may derive the abbreviated backward induction function based on inputting the local value function into the global backward induction by validating that the expectation can be satisfied by the abbreviated local equation:

$$- {v}_{t} = C + {v}_{x} A ,$$

as described herein.

At step 410, the computational unit may generate and/or otherwise derive a selection policy. The selection policy may comprise one or more parameters for determining optimal actions to achieve an objective with an optimized chosen statistic of a distribution of total future cost. The one or more parameters may comprise rules, decision trees, a world state geometry, a real or simulated world state, an optimal number of dimensions for determining how to achieve an objective, an optimal scale for determining how to achieve an objective, and/or other parameters as described herein. The optimized chosen statistic may comprise one or more of: a percentile distribution of expected future costs for achieving the objective, a maximum total future cost, an expectation of the total future cost, an average of a subset of expected future costs for achieving the objective, and/or any other optimized chosen statistics. The basis for choosing the selection policy may come from the backward induction function.

In some examples, the computational unit may generate and/or otherwise derive the selection policy based on an oracle bootstrap method as described herein. For example, based on an initial oracle-based forward induction, the computational unit may generate an initial selection policy that couples the forward induction algorithm to the backward induction function based on generating a set of states that can be used to compute an initial guess for the local value function v, as described herein.

As described herein, the forward induction algorithm may depend on knowledge of the selection policy. In some examples, the forward induction algorithm may be coupled to the backward induction algorithm through the selection policy. As such, the functions described herein at steps 406-410 may be performed in any order and/or together without departing from the scope of this disclosure.

The computational unit may utilize the forward induction algorithm, backward induction function, and/or selection policy as described herein to determine optimal actions for achieving a goal. For example, based on completing the functions described at steps 402-410, the computational unit may initiate a coupled induction loop using the forward induction algorithm coupled to the backward induction function via the selection policy. The coupled induction loop may comprise performing a sequence of steps until convergence is identified.

In some examples, the computational unit may perform the functions recited at steps 412-418 as part of performing doubly-exponentially accelerated particle methods as described herein. For example, during the coupled induction loop, the computational unit may perform a backward sweep at step 412, update a selection policy at step 414, perform a forward sweep at step 416, and repeat these steps until convergence is identified at step 418.

In performing the backward sweep at step 412, the computational unit may execute the backward induction function. For example, the computational unit may execute the backward induction function of step 408 to determine rewards (e.g., expected values, represented by a value function) for performing one or more actions. In some examples, the computational unit may perform the backward sweep at step 412 at the start of the coupled induction loop by executing the backward induction function to determine knowledge of the selection policy for use in executing the forward induction algorithm. Additionally and/or alternatively, the computational unit may perform steps 412, 414, and 416 in a different order.

At step 414, the computational unit may update a policy. For example, the computational unit may update the selection policy for determining optimal actions to achieve the objective with an optimized chosen statistic of a distribution of future cost. In some examples, updating the selection policy may comprise updating the selection policy based on the uninformed probability distribution p and the value function v, as described herein. The computational unit may initially update the selection policy based solely on performing the backward induction function if, for example, step 412 is the first step of the coupled induction loop. Additionally or alternatively, the computational unit may update the selection policy based on performing the backward induction function and the forward induction algorithm. For example, the computational unit may update the selection policy with the optimization:

$$0 = {C}_{a} + {E}_{p ( t )} [ {v}_{x} {A}_{a} \vert i ( t ) ]$$

$$and / or$$

$$a = {C}_{a}^{- 1} ( - {E}_{p ( t )} [ {v}_{x} {A}_{a} \vert i ( t ) ] ) .$$

At step 416, the computational unit may perform a forward sweep. In performing the forward sweep, the computational unit may execute the forward induction algorithm to provide a forward induction on probability information (e.g., an uncertainty) of an unknown state of a real or simulated world.

At step 418, based on completing at least one iteration of the coupled induction loop (e.g., by performing steps 412-416), the computational unit may identify whether convergence is achieved for one or more optimal actions. For example, the computational unit may determine whether one or more candidates for optimal actions indicated and/or otherwise selected by the selection policy converge. If so, the candidates may be identified as one or more optimal actions for achieving the objective as an optimal value of the optimized chosen statistic. For example, the candidates may be identified as optimal actions for achieving the objective as an optimal value of a chosen statistics such as a worst-case cost, a percentile of the distribution of costs for achieving the objective, a variance of the cost for achieving the objective, and/or any other statistic of the distribution of costs for achieving the objective. Based on identifying that convergence has been achieved for one or more optimal actions, the computational unit may proceed to output the one or more optimal actions as described at step 420. Based on identifying that convergence has not yet been achieved for any candidate optimal actions, the computational unit may continue to a next iteration of the coupled induction loop (e.g., by repeating the functions described at steps 412-418) and may continue to update the selection policy during the coupled induction loop by alternating between the backward induction and the forward induction.

At step 420, based on identifying that convergence has been achieved for one or more optimal actions, the computational unit may output the one or more optimal actions. In some examples, in outputting the one or more optimal actions, the computational unit may output an indication of the one or more optimal actions. For example, the computational unit may send, transmit, and/or otherwise relay a list of optimal actions, instructions for performing the optimal actions, and/or other indications of the optimal actions to a user device (e.g., user device 301). Additionally and/or alternatively, in outputting the one or more optimal actions, the computational unit may effect, via an actuator, the one or more optimal actions.

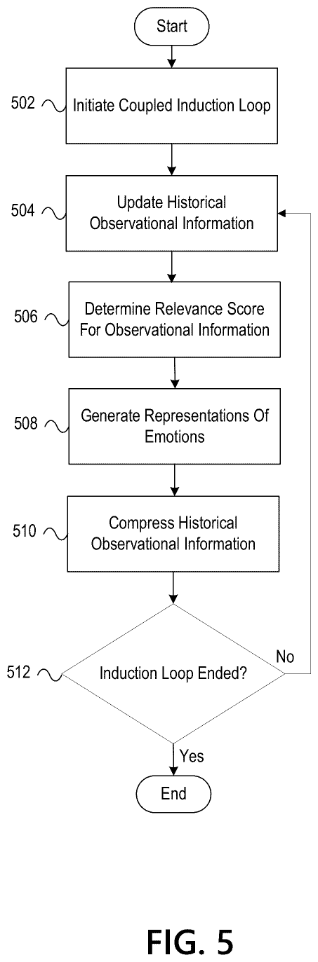

The steps of performing a doubly-exponentially accelerated particle method described herein may be optimized, improved, accelerated, and/or otherwise modified by other methods described herein. FIG. 5 illustrates steps of accelerating particle methods using representations of emotions as part of an acceleration method 500. Referring to FIG. 5, at step 502, a computational unit (e.g., computational unit 302) may initiate a coupled induction loop. For example, the computational unit may initiate the coupled induction loop as described herein with respect to FIG. 4.

At step 504, the computational unit may update historical observational information. For example, the computational unit may update observational information with new observational information. In some examples, the new observational information may comprise current observations received by one or more sensors and corresponding to a real or simulated world state. In updating the historical observational information, the computational unit may update stored information corresponding to the variable i(t), representing the history of observational information.

At step 506, the computational unit may determine a relevance score for stored observational information. For example, the computational unit may analyze the updated historical observational information to determine a subset of the information that is the most relevant to the objective. In some examples, the computational unit may determine separate relevance scores for portions of the stored observational information. In determining the relevance scores, the computational unit may perform one or more mathematical operations to identify, based on statistics of future outcomes of performing actions based on the portions of the stored observational information, a relevance score for each portion of the observational information. For example, a given relevance score may comprise and/or be based on statistics of a current cost and an expected future cost of performing one or more actions that may, for example, be candidate optimal actions considered by the selection policy. The relevance score may comprise an integer value, a decimal value, a percentage, a fraction, and/or any other representation of the relevance of the portion of the observational information in achieving the objective. It should be understood that, while the example of determining relevance scores is described, the computational unit may additionally and/or alternatively perform different steps for determining a hierarchy of which portions of stored observational information are most to least relevant for achieving the objective.

At step 508, the computational unit may generate one or more representations of emotions. For example, the computational unit may generate mathematical representations of emotions such as tension, fear, happiness, anger, or the like. The representations of emotions may comprise mathematical representations of a plurality of combined relevance scores. For example, a representation of the fear emotion may comprise a combination of relevance scores corresponding to a chosen statistic, such as a variance of the expectation of future costs up to a time horizon. It should be understood that the above description is merely an example and that representations of emotions may comprise representations of other emotions and/or other statistics described herein.

At step 510, based on generating the one or more representations of emotions, the computational unit may compress the stored historical observational information. For example, the computational unit may execute one or more compression algorithms to reduce the memory required to store the historical information. In some examples, compressing the stored historical observational unit may comprise deleting and/or otherwise removing stored historical observational information that corresponds to certain emotions. For example, the computational unit may remove stored historical observational information corresponding to emotions comprising mathematical representations of relevance score below a relevance threshold. Additionally and/or alternatively, compressing the stored historical observational information may comprise combining information corresponding to emotions with similar relevance scores. Compressing the historical observational information may accelerate particle methods described herein by filtering the amount of information used in the coupled induction loop, thereby conserving resources and optimizing the coupled induction loop. Compressing the historical observational information may additionally and/or alternatively modify the forward induction step of the coupled induction loop by causing the computational unit to determine, based on the compressed historical observational information, informed state distributions for a real or simulated world state during the coupled induction loop.

At step 512, the computational unit may determine whether the coupled induction loop has ended. For example, the computational unit may determine whether convergence has been achieved, as described herein. Based on determining that the coupled induction loop has not ended, the computational unit may repeat steps 504-512 as part of a continuous loop for optimizing memory storage based on representations of emotions. Based on determining that the coupled induction loop has ended, the computational unit may end the acceleration method 500.

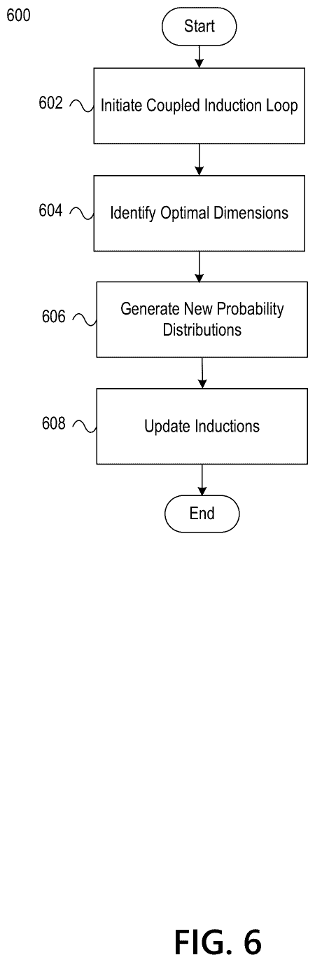

FIG. 6 illustrates steps of accelerating particle methods using dimensional reduction. For example, FIG. 6 illustrates a dimensional reduction acceleration method 600. Referring to FIG. 6, at step 602, a computational unit (e.g., computational unit 302) may initiate a coupled induction loop. For example, the computational unit may initiate the coupled induction loop as described herein with respect to FIG. 4.

At step 604, the computational unit may identify optimal dimensions for the coupled induction loop. For example, the computational unit may identify the optimal dimensions by determining, based on one or more parameters, one or more optimal dimensions for computing the one or more optimal actions for achieving the objective. In some examples, the one or more parameters may comprise parameters received by the computational unit from a user device, as described herein. For example, the computational unit may have previously received parameters indicating a number of dimensions that are relevant to the objective. Dimensions representing a world state that is far away or unobservable, for example, may not be relevant to a given objective. For example, in a scenario where the objective is to determine which of two pots of coffee to retrieve coffee from, any dimensions related to the actual location of the coffee pots is not relevant before observational information indicating the location of the coffee pots is acquired.

At step 606, based on the one or more optimal dimensions, the computational unit may generate new probability distributions. For example, the computational unit may generate one or more updated probability distributions corresponding to a state of a real or virtual world. In generating the updated probability distributions, the computational unit may reduce the number of dimensions represented in previously-generated probability distributions.

At step 608, based on generating the new probability distributions, the computational unit may update the forward induction and/or the backward induction. For example, the computational unit may update the forward induction and/or the backward induction during the coupled induction loop and based on the one or more updated probability distributions. The computational unit may update the forward induction and/or the backward induction by updating informed state distributions used during the coupled induction loop.

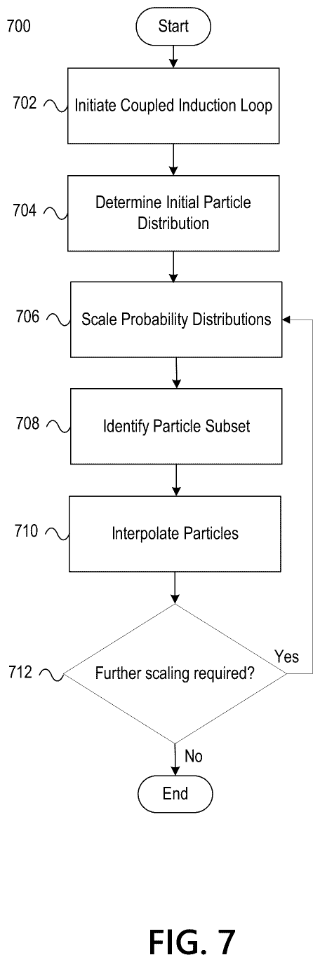

FIG. 7 illustrates steps of accelerating particle methods using multi-scaling methods. For example, FIG. 7 illustrates a multi-scaling acceleration method 700. Referring to FIG. 7, at step 702, a computational unit (e.g., computational unit 302) may initiate a coupled induction loop. For example, the computational unit may initiate the coupled induction loop as described herein with respect to FIG. 4.

At step 704, the computational unit may determine an initial particle distribution. For example, the computational unit may generate an initial particle distribution as described at step 402 herein. The initial particle distribution may correspond to (e.g., comprise, represent, and/or otherwise be associated with) information of an unknown state of a real or simulated world, information of an uninformed probability distribution, information of one or more historical observable states, an indication of a selection policy, a value function corresponding to the objective, an expectation of the value function, and/or any other information, functions, or the like used to perform particle methods as described herein.

At step 706, the computational unit may scale one or more probability distributions. For example, the computational unit may scale up interaction distances and speeds of motion in the world mechanics, to create a coarse version of a problem that must be solved to achieve the objective. Scaling the interaction distances and speeds of motion in the world mechanics may modify the vector and/or sequence of vectors i(t) representing one or more historical observable states and/or historical observed information:

$$i ( t ) = y ( 0 ) ... y ( t ) .$$

At step 708, the computational unit may identify a subset of particles. For example, the computational unit may identify a subset of the initial particle distribution generated at step 706. In identifying the subset of the particles, the computational unit may identify finer scale particles in a particular neighborhood of the coarse version of the problem. In some examples, the computational unit may identify one or more additional subsets of particles for additional neighborhoods of the coarse version of the problem.

At step 710, based on identifying the subset of particles, the computational unit may interpolate the subset of particles. For example, the computational unit may interpolate the subset of particles in a specific neighborhood (e.g., a collection of neighboring particles within a predetermine distance of each other). As part of and/or based on interpolating the particles, the computational unit may update the coupled induction loop by adding a scale to the solution to the objective computed by the coupled induction loop. The final solution (e.g., the determination of one or more optimal actions) may be computed on the finest scale, resulting in improvements to efficiency by limiting the number of particles required to achieve the objective.

At step 712, the computational unit may determine whether further scaling is required. For example, the computational unit may determine whether one or more parameters, rules, user instructions, or the like require the computational unit to add more scales to the coupled induction loop. Based on determining that further scaling is required, the computational unit may repeat steps 706-712 to produce multi-scaled solutions to the problem of how to achieve the objective. Based on determining that no further scaling is required, the computational unit may end the multi-scaling acceleration method 700 and proceed to compute the final solution by iterating through the coupled induction loop as described herein.

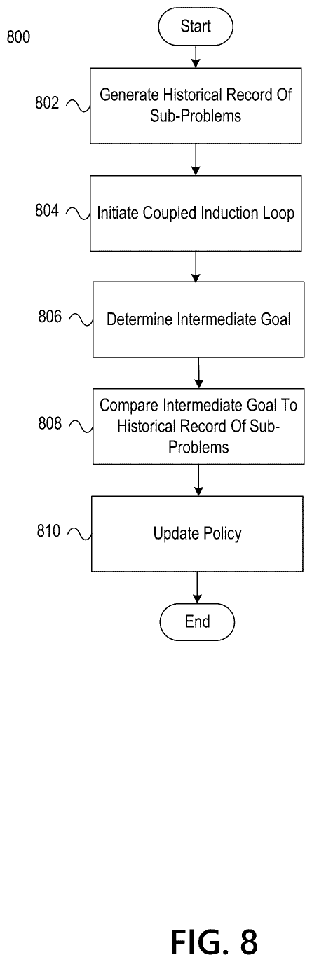

FIG. 8 illustrates steps of accelerating particle methods using abstraction through problem decomposition. For example, FIG. 8 illustrates a problem decomposition method 800. Referring to FIG. 8, at step 802, a computational unit (e.g., computational unit 302) may generate a historical record of sub-problems. For example, the computational unit may generate a historical record of one or more sub-problems that were solved as part of achieving an objective. The historical record may comprise, for example, a record of the steps of identifying which pot of coffee, between two pots of coffee, contained fresh coffee, identifying the location of a cup, identifying the mechanics of the coffee pot, and pouring the coffee into the cup, cumulatively comprising the steps to achieve the objective of pouring a cup of coffee.

In some examples, the computational unit may generate the historical record of sub-problems based on sub-problems identified in one or more previously effected iterations of the coupled induction loop as described herein with respect to FIG. 4. In generating the historical record of sub-problems, the computational unit may generate a library of repeated sub-problems that arise in a plurality of similar objectives. It should be understood that the computational unit may continuously or near-continuously update the historical record of sub-problems as additional iterations of the coupled induction loop are performed.

At step 804, at some time after initially generating the historical record of sub-problems, the computational unit may initiate the coupled induction loop. For example, the computational unit may initiate a new iteration of the coupled induction loop described with respect to FIG. 4 herein.

At step 806, the computational unit may determine an intermediate goal for achieving the objective. For example, the computational unity may identify one or more lower dimensional problems that involve only a subset of objects in the real or virtual world state corresponding to the objective. The intermediate goal may comprise one or more steps for causing the subset of the objects to interact in some manner to solve a sub-problem of the objective.

At step 808, the computational unit may compare the intermediate goal to the historical record of sub-problems. For example, the computational unit may analyze the requirements for achieving the intermediate goal against the historical record of sub-problems in order to identify one or more sub-problems that have previously been solved by the computational unit using methods described herein. In comparing the intermediate goal to the historical record of sub-problems, the computational unit may identify archived solutions to the sub-problem and/or set of historical sub-problems that is the subject of the intermediate goal.

At step 810, based on comparing the intermediate goal to the historical record of sub-problems, the computational unit may update the selection policy. For example the computational unit may update the selection policy based on the set of historical sub-problems corresponding to the intermediate goal. In updating the selection policy, the computational unit may provide candidate actions for the selection policy to propose that solve the historical set of sub-problems. In these examples, the computational unit may increase the speed of the particle methods described herein by reducing the computational time needed to achieve the objective.

### III. Illustrative Use Case Scenario

The components of the described doubly-exponentially accelerated particle method will now be explained in an example of a personal assistant. In this example, this personal assistant may be specifically concerned with helping the user acquire a cup of coffee.

The device configuration may include the user's own commodity smartphone as the user device, and a remote server farm maintained by a service provider as the computational unit. These two may communicate over the wireless and wired Internet. To sign up, the user may install an application onto the smartphone that collects observational data from the smartphone's built in sensors, such as GPS (location), clock (time), camera (visual input), microphone (acoustic input), keyboard (text input), and readable custom data from other applications. The application may also effect actions and express emotions using the smartphone's built in actuators, such as display (visual output), speaker (acoustic output), vibration (kinetic output), and writeable custom data to other applications. This application may collect time, location, environmental (from sensors on the smartphone), and user commands (via keyboard or speech-to-text). This application may provide the user with recommended actions either visually or acoustically; visually, the application may display text, maps, and emotion icons; acoustically, the application may use text-to-speech to state recommended actions, with different tones of voice to indicate different emotions.

The computational unit may then define and/or otherwise maintain an objective. For example, the computational unit may receive user input indicating the objective of acquiring coffee from a room with two coffee pots. The computational unit may generate probability distributions and a selection policy based on the observational information available to the computational unit via the application. The selection policy may be configured to achieve the objective with an optimized chosen statistic of a distribution of future cost, as described herein.

The computational unit then may perform a series of backward and forward sweeps as part of a coupled induction loop based on the probability distributions (e.g., using an initial distribution of particles) in order to achieve an optimal action to relay to the user device. During the backward sweep, the computational unit may effect the backward induction function described herein. During the forward sweep, the computational unit may effect the forward induction algorithm described herein. The computational unit may optimize the selection policy based on the forward induction and the backward induction. The process continues until candidate optimal actions identified by the selection policy are determined to be optimal actions by the backward sweep and the forward sweep (e.g., by converging). The method performed by the computational unit may be doubly-exponentially accelerated by any of the methods described herein.

After completing the doubly-exponentially accelerated particle method, the computational unit may relay one or more optimal actions to the user device. The user device may provide a recommended action u, either by text on the display or by text-to-speech through the speaker. This recommended action could consist of checking both coffee pots to determine which coffee pot has coffee, checking the temperature of the coffee in each pot, and/or any other action for achieving the objective based on an optimized chosen statistic.

The strategies determined by this method may plan ahead to achieve long-term goals. For example, if the coffee pots are both empty, the algorithm may recommend that the user brew a fresh pot of coffee so that the user may have access to coffee later.

The strategies may take these uncertainties into account. For example, if the two coffee pots are identical, the method may recommend pouring a cup of coffee from each, testing both cups, and determining which cup the user prefers.

The strategies may be flexibly adapted in real-time in response to events. For example, if the user grabs a first pot of coffee but spills it, the method may recommend pouring coffee from the second pot of coffee. The user may receive recommended actions until the objective, such as acquiring coffee, is achieved.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

The following paragraphs (M1) through (M56) describe examples of methods that may be implemented in accordance with the present disclosure.

(M1) A method comprising: identifying, by a computational unit, an objective; generating one or more initial probability distributions corresponding to an initial uncertainty of a real or simulated world state; generating a selection policy, wherein the selection policy comprises one or more parameters for determining optimal actions to achieve the objective with an optimized chosen statistic of a distribution of future cost; determining, through a coupled induction loop and based on the one or more initial probability distributions, one or more optimal actions to achieve the objective with the optimized chosen statistic, wherein the coupled induction loop comprises: performing a backward induction on the optimized chosen statistic; performing a forward induction on an uncertainty about an unknown state of the world; updating, based on the backward induction and the forward induction, the selection policy; and repeating the backward induction, the updating, and the forward induction until convergence is identified; and outputting an indication of the one or more optimal actions.

(M2) The method as described in paragraph (M1), further comprising: determining a first number t, which represents a future time; determining a first vector x, which represents an unknown state of a real or simulated world at time t; determining a second vector y, which represents an observable state at time t; determining a first function M(x), which is a measurement function corresponding to the second vector y; and determining a cost function corresponding to the observable state, wherein identifying the objective comprises defining the objective based on the first number t, the first vector x, the second vector y, the first function M(x), and the cost function.

(M3) The method as described in paragraph (M2), further comprising: determining a sequence of vectors i, wherein the series of vectors i represents one or more historical observable states; determining, based on the first vector x and the series of vectors i, lifted dynamics of the selection policy; determining, based on the lifted dynamics of the selection policy, an uninformed probability distribution p(t), wherein the uninformed probability distribution p(t) corresponds to the one or more initial probability distributions; and deriving, based on the uninformed probability distribution, the forward induction.

(M4) The method as described in paragraph (M3), further comprising: determining a value function v(t)(x,i), wherein an expectation of the value function v(t)(x,i) is defined by:

$$V ( s ( t ) ) = {E}_{s ( t )} [ x \to v ( t ) ( x , i ( t ) ) ] = {E}_{p ( t )} [ v ( t ) \vert i ( t ) ] ;$$

inputting the value function v(t)(x,i) into a global backward induction yielding:

$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$

and deriving, based on inputting the value function v(t)(x,i) into the global backward induction, the backward induction.

(M5) The method as described in paragraph (M4), wherein updating the selection policy comprises optimizing, based on the uninformed probability distribution p(t) and the value function v(t)(x,i), the selection policy.

(M6) The method as described in any of paragraphs (M1) through (M5), wherein the optimized chosen statistic comprises: a percentile distribution of expected future costs for achieving the objective, a maximum total future cost, an expectation of the total future cost, or an average of a subset of expected future costs for achieving the objective.

(M7) The method as described in any of paragraphs (M1) through (M6), further comprising receiving, by a sensor, a current observation corresponding to the real or simulated world state; updating, based on the current observation, historical observable state information; determining, based on the historical observable state information, a relevance score for the current observation, wherein the relevance score comprises statistics of a current cost and a statistic of a distribution of future cost of performing one or more actions; generating, based on the relevance score, one or more mathematical representations of emotions; and compressing, based on the one or more mathematical representations of emotions, the historical observable state information, wherein performing the forward induction comprises determining, based on the compressed historical observable state information, informed state distributions for the real or simulated world state.

(M8) The method as described in any of paragraphs (M1) through (M7), further comprising: determining, based on the one or more parameters, one or more optimal dimensions for computing the one or more optimal actions; generating, based on the one or more optimal dimensions, one or more updated probability distributions corresponding to a state of the world; and updating, during the coupled induction loop and based on the one or more updated probability distributions, the forward induction and the backward induction.

(M9) The method as described in any of paragraphs (M1) through (M8), further comprising: determining an initial particle distribution, wherein the initial particle distribution corresponds to: information of an unknown state of a real or simulated world at a time t; information of an uninformed probability distribution p(t), information of one or more historical observable states, an indication of the selection policy, and a value function corresponding to the objective; performing a multi-scaling method, wherein the multi-scaling method comprises: scaling up interaction distances and speeds of motion in world mechanics corresponding to the one or more initial probability distributions; identifying a subset of particles of the initial particle distribution; interpolating the subset of particles; and repeating the scaling, identifying subsets of particles, and interpolating until an optimal number of scales is achieved; and updating, based on completion of the multi-scaling method, the coupled induction loop.

(M10) The method as described in any of paragraphs (M1) through (M9), further comprising: generating, based on optimal actions for achieving historical objectives, a historical record of sub-problems for historical objectives; determining an intermediate goal for the objective; comparing, based on the historical record of sub-problems, the intermediate goal to one or more historical sub-problems; determining, based on the comparing, a set of historical sub-problems corresponding to the intermediate goal; and updating, based on the set of historical sub-problems, the selection policy.

(M11) The method as described in any of paragraphs (M1) through (M10), further comprising bootstrapping the forward induction and the backward induction with an initial oracle-based forward induction, wherein the initial oracle-based forward induction chooses actions based on unobserved information about the real or simulated world state.

(M12) The method as described in any of paragraphs (M1) through (M11), further comprising effecting, via an actuator, the one or more optimal actions.

(M13) The method as described in any of paragraphs (M1) through (M12), wherein the computational unit supports calculation of multi-valued functions.

(M14) The method as described in any of paragraphs (M1) through (M13), further comprising restricting numerical calculations performed by the computational unit to a local data manifold within a full-dimensional space of states.

(M15) A method comprising: receiving, by a sensor, observational information; maintaining, by a computational unit, an objective corresponding to the objective information; maintaining, by the computational unit, a current uncertainty about an unknown state, wherein the current uncertainty is updated using the observational information; generating a selection policy, wherein the selection policy comprises one or more parameters for determining optimal actions to achieve the objective with an optimized chosen statistic of a distribution of future cost; and determining, by the computational unit and based on the selection policy, one or more optimal actions to achieve the objective as an optimal value of the optimized chosen statistic, wherein said determining comprises performing both backward induction on the optimized chosen statistic and forward induction on the uncertainty about the unknown state.

(M16) The method as described in paragraph (M15), further comprising: determining a first number t, which represents a future time; determining a first vector x, which represents an unknown state of a real or simulated world at time t; determining a second vector y, which represents an observable state at time t; determining a first function M(x), which is a measurement function corresponding to the second vector y; and determining a cost function corresponding to the observable state, wherein maintaining the objective comprises defining the objective based on the first number t, the first vector x, the second vector y, the first function M(x), and the cost function.

(M17) The method as described in paragraph (M16), further comprising: determining a sequence of vectors i, wherein the series of vectors i represents one or more historical observable states; determining, based on the first vector x and the series of vectors i, lifted dynamics of the selection policy; determining, based on the lifted dynamics of the selection policy, an uninformed probability distribution p(t), wherein the uninformed probability distribution p(t) corresponds to one or more initial probability distributions; and deriving, based on the uninformed probability distribution, the forward induction.

(M18) The method as described in paragraph (M17), further comprising: determining a value function v(t)(x,i), wherein an expectation of the value function v(t)(x,i) is defined by:

$$V ( s ( t ) ) = {E}_{s ( t )} [ x \to v ( t ) ( x , i ( t ) ) ] = {E}_{p ( t )} [ v ( t ) \vert i ( t ) ] ;$$

inputting the value function v(t)(x,i) into a global backward induction yielding:

$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$

and deriving, based on inputting the value function v(t)(x,i) into the global backward induction, the backward induction.

(M19) The method as described in paragraph (M18), wherein determining the one or more actions comprises optimizing, based on the uninformed probability distribution p(t) and the value function v(t)(x,i), the selection policy.

(M20) The method as described in any of paragraphs (M15) through (M19), wherein the optimized chosen statistic comprises: a percentile distribution of expected future costs for achieving the objective, a maximum total future cost, an expectation of the total future cost, or an average of a subset of expected future costs for achieving the objective.

(M21) The method as described in any of paragraphs (M15) through (M20), further comprising: receiving, by the sensor, a current observation corresponding to the real or simulated world state; updating, based on the current observation, historical observable state information; determining, based on the historical observable state information, a relevance score for the current observation, wherein the relevance score comprises statistics of a current cost and a statistic of a distribution of future cost of performing one or more actions; generating, based on the relevance score, one or more mathematical representations of emotions; and compressing, based on the one or more mathematical representations of emotions, the historical observable state information, wherein performing the forward induction comprises determining, based on the compressed historical observable state information, informed state distributions for the real or simulated world state.

(M22) The method as described in any of paragraphs (M15) through (M21), further comprising: determining, based on the one or more parameters, one or more optimal dimensions for computing the one or more optimal actions; generating, based on the one or more optimal dimensions, one or more updated probability distributions corresponding to a state of the world; and updating, during the determining the one or more optimal actions and based on the one or more updated probability distributions, the forward induction and the backward induction.

(M23) The method as described in any of paragraphs (M15) through (M22), further comprising: determining an initial particle distribution, wherein the initial particle distribution corresponds to: information of an unknown state of a real or simulated world at a time t; information of an uninformed probability distribution p(t), information of one or more historical observable states, an indication of the selection policy, and a value function corresponding to the objective; performing a multi-scaling method, wherein the multi-scaling method comprises: scaling up interaction distances and speeds of motion in world mechanics corresponding to the one or more initial probability distributions; identifying a subset of particles of the initial particle distribution; interpolating the subset of particles; and repeating the scaling, identifying subsets of particles, and interpolating until an optimal number of scales is achieved; and updating, based on completion of the multi-scaling method, the backward induction and the forward induction.

(M24) The method as described in any of paragraphs (M15) through (M23), further comprising: generating, based on optimal actions for achieving historical objectives, a historical record of sub-problems for historical objectives; determining an intermediate goal for the objective; comparing, based on the historical record of sub-problems, the intermediate goal to one or more historical sub-problems; determining, based on the comparing, a set of historical sub-problems corresponding to the intermediate goal; and updating, based on the set of historical sub-problems, the selection policy.

(M25) The method as described in any of paragraphs (M15) through (M24), further comprising bootstrapping the forward induction and the backward induction with an initial oracle-based forward induction, wherein the initial oracle-based forward induction chooses actions based on unobserved information about the real or simulated world state.

(M26) The method as described in any of paragraphs (M15) through (M25), further comprising effecting, via an actuator, the one or more optimal actions.

(M27) The method as described in any of paragraphs (M15) through (M26), wherein the computational unit supports calculation of multi-valued functions.

(M28) The method as described in any of paragraphs (M15) through (M27), further comprising restricting numerical calculations performed by the computational unit to a local data manifold within a full-dimensional space of states.

(M29) A method for optimizing acquisition of data, in furtherance of an objective, comprising: maintaining, by a computational unit, the objective; representing the objective using an incremental cost of a plurality of potential actions, wherein the plurality of potential actions comprises one or more actions associated with an optimal contingent strategy for achieving the objective as an optimal value of an optimized chosen statistic of a distribution of future cost that, when performed, produce observational information; acquiring, via one or more sensors, based on performing, during execution of the optimal contingent strategy, the one or more actions and based on prior observational information acquired by the one or more sensors, the observational information; providing, to a model that is selecting the optimal contingent strategy, the observational information, wherein providing the observational information configures the model to determine one or more optimal future actions for achieving the objective; and determining, by the computational unit and using the model, one or more optimal future actions to achieve the objective, wherein the determining the one or more optimal future actions comprises repeating a backward induction and a forward induction until convergence is identified.

(M30) The method as described in paragraph (M29), further comprising: determining a first number t, which represents a future time; determining a first vector x, which represents an unknown state of a real or simulated world at time t; determining a second vector y, which represents an observable state at time t; determining a first function M(x), which is a measurement function corresponding to the second vector y; and determining a cost function corresponding to the observable state, wherein maintaining the objective comprises defining the objective based on the first number t, the first vector x, the second vector y, the first function M(x), and the cost function.

(M31) The method as described in paragraph (M30), further comprising: determining a sequence of vectors i, wherein the series of vectors i represents one or more historical observable states; determining, based on the first vector x and the series of vectors i, lifted dynamics of the selection policy; determining, based on the lifted dynamics of the selection policy, an uninformed probability distribution p(t), wherein the uninformed probability distribution p(t) corresponds to the one or more initial probability distributions; and deriving, based on the uninformed probability distribution, the forward induction.

(M32) The method as described in paragraph (M31), further comprising: determining a value function v(t)(x,i), wherein an expectation of the value function v(t)(x,i) is defined by:

$$V ( s ( t ) ) = {E}_{s ( t )} [ x \to v ( t ) ( x , i ( t ) ) ] = {E}_{p ( t )} [ v ( t ) \vert i ( t ) ] ;$$

inputting the value function v(t)(x,i) into a global backward induction yielding:

$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$

and deriving, based on inputting the value function v(t)(x,i) into the global backward induction, the backward induction.

(M33) The method as described in paragraph (M32), wherein determining the one or more optimal actions comprises optimizing, based on the uninformed probability distribution p(t) and the value function v(t)(x,i), a selection policy.

(M34) The method as described in any of paragraphs (M29) through (M33), wherein the optimized chosen statistic comprises: a percentile distribution of expected future costs for achieving the objective, a maximum total future cost, an expectation of the total future cost, or an average of a subset of expected future costs for achieving the objective.

(M35) The method as described in any of paragraphs (M29) through (M34), further comprising: receiving, by one or more sensors, a current observation corresponding to a real or simulated world state; updating, based on the current observation, historical observable state information; determining, based on the historical observable state information, a relevance score for the current observation, wherein the relevance score comprises statistics of a current cost and a statistic of a distribution of future cost of performing one or more actions; generating, based on the relevance score, one or more mathematical representations of emotions; and compressing, based on the one or more mathematical representations of emotions, the historical observable state information, wherein performing the forward induction comprises determining, based on the compressed historical observable state information, informed state distributions for the real or simulated world state.

(M36) The method as described in any of paragraphs (M29) through (M35), further comprising: determining, based on one or more parameters for determining optimal actions, one or more optimal dimensions for computing the one or more optimal actions; generating, based on the one or more optimal dimensions, one or more updated probability distributions corresponding to a state of the world; and updating, during the determining the one or more optimal actions and based on the one or more updated probability distributions, the forward induction and the backward induction.

(M37) The method as described in any of paragraphs (M29) through (M36), further comprising: determining an initial particle distribution, wherein the initial particle distribution corresponds to: information of an unknown state of a real or simulated world at a time t; information of an uninformed probability distribution p(t), information of one or more historical observable states, an indication of the selection policy, and a value function corresponding to the objective; performing a multi-scaling method, wherein the multi-scaling method comprises: scaling up interaction distances and speeds of motion in world mechanics corresponding to the one or more initial probability distributions; identifying a subset of particles of the initial particle distribution; interpolating the subset of particles; and repeating the scaling, identifying subsets of particles, and interpolating until an optimal number of scales is achieved; and updating, based on completion of the multi-scaling method, the forward induction and the backward induction.

(M38) The method as described in any of paragraphs (M29) through (M37), further comprising: generating, based on optimal actions for achieving historical objectives, a historical record of sub-problems for historical objectives; determining an intermediate goal for the objective; comparing, based on the historical record of sub-problems, the intermediate goal to one or more historical sub-problems; determining, based on the comparing, a set of historical sub-problems corresponding to the intermediate goal; and updating, based on the set of historical sub-problems, a selection policy for achieving the objective.

(M39) The method as described in any of paragraphs (M29) through (M38), further comprising bootstrapping the forward induction and the backward induction with an initial oracle-based forward induction, wherein the initial oracle-based forward induction chooses actions based on unobserved information about a real or simulated world state.

(M40) The method as described in any of paragraphs (M29) through (M39), further comprising effecting, via an actuator, the one or more optimal actions.

(M41) The method as described in any of paragraphs (M29) through (M40), wherein the computational unit supports calculation of multi-valued functions.

(M42) The method as described in any of paragraphs (M29) through (M41), further comprising restricting numerical calculations performed by the computational unit to a local data manifold within a full-dimensional space of states.

(M43) A method for constructing an efficient memory, in furtherance of an objective, comprising: maintaining, by a computational unit, the objective; representing the objective using an incremental cost of a plurality of potential actions; acquiring observational data, directly or indirectly, as a result of performing the plurality of potential actions; selecting a subset of the observational data to include in a memory unit based on one or more statistics of a distribution of total current and future cost at the time that the data is acquired; and determining, by the computational unit and based on the subset of the observational data, one or more optimal actions to achieve the objective as an optimal value of an optimized chosen statistic of a distribution of future cost, wherein determining the one or more optimal actions comprises repeating a backward induction and a forward induction until convergence is identified.

(M44) The method as described in paragraph (M43), further comprising: determining a first number t, which represents a future time; determining a first vector x, which represents an unknown state of a real or simulated world at time t; determining a second vector y, which represents an observable state at time t; determining a first function M(x), which is a measurement function corresponding to the second vector y; and determining a cost function corresponding to the observable state, wherein maintaining the objective comprises defining the objective based on the first number t, the first vector x, the second vector y, the first function M(x), and the cost function.

(M45) The method as described in paragraph (M44), further comprising: determining a sequence of vectors i, wherein the series of vectors i represents one or more historical observable states; determining, based on the first vector x and the series of vectors i, lifted dynamics of a selection policy; determining, based on the lifted dynamics of the selection policy, an uninformed probability distribution p(t), wherein the uninformed probability distribution p(t) corresponds to the one or more initial probability distributions; and deriving, based on the uninformed probability distribution, the forward induction.

(M46) The method as described in paragraph (M45), further comprising: determining a value function v(t)(x,i), wherein an expectation of the value function v(t)(x,i) is defined by:

$$V ( s ( t ) ) = {E}_{s ( t )} [ x \to v ( t ) ( x , i ( t ) ) ] = {E}_{p ( t )} [ v ( t ) \vert i ( t ) ] ;$$

inputting the value function v(t)(x,i) into a global backward induction yielding:

$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$

and deriving, based on inputting the value function v(t)(x,i) into the global backward induction, the backward induction.

(M47) The method as described in paragraph (M46), wherein determining the one or more optimal actions comprises optimizing, based on the uninformed probability distribution p(t) and the value function v(t)(x,i), the selection policy.

(M48) The method as described in any of paragraphs (M43) through (M47), wherein the optimized chosen statistic comprises: a percentile distribution of expected future costs for achieving the objective, a maximum total future cost, an expectation of the total future cost, or an average of a subset of expected future costs for achieving the objective.

(M49) The method as described in any of paragraphs (M43) through (M48), further comprising: receiving, by one or more sensors, a current observation corresponding to a real or simulated world state; updating, based on the current observation, historical observable state information; determining, based on the historical observable state information, a relevance score for the current observation, wherein the relevance score comprises statistics of a current cost and a statistic of a distribution of future cost of performing one or more actions; generating, based on the relevance score, one or more mathematical representations of emotions; and compressing, based on the one or more mathematical representations of emotions, the historical observable state information, wherein performing the forward induction comprises determining, based on the compressed historical observable state information, informed state distributions for the real or simulated world state.

(M50) The method as described in any of paragraphs (M43) through (M49), further comprising: determining, based on one or more parameters for determining optimal actions, one or more optimal dimensions for computing the one or more optimal actions; generating, based on the one or more optimal dimensions, one or more updated probability distributions corresponding to a state of the world; and updating, during the determining the one or more optimal actions and based on the one or more updated probability distributions, the forward induction and the backward induction.

(M51) The method as described in any of paragraphs (M43) through (M50), further comprising: determining an initial particle distribution, wherein the initial particle distribution corresponds to: information of an unknown state of a real or simulated world at a time t; information of an uninformed probability distribution p(t), information of one or more historical observable states, an indication of a selection policy, and a value function corresponding to the objective; performing a multi-scaling method, wherein the multi-scaling method comprises: scaling up interaction distances and speeds of motion in world mechanics corresponding to the one or more initial probability distributions; identifying a subset of particles of the initial particle distribution; interpolating the subset of particles; and repeating the scaling, identifying subsets of particles, and interpolating until an optimal number of scales is achieved; and updating, based on completion of the multi-scaling method, the forward induction and the backward induction.

(M52) The method as described in any of paragraphs (M43) through (M51), further comprising: generating, based on optimal actions for achieving historical objectives, a historical record of sub-problems for historical objectives; determining an intermediate goal for the objective; comparing, based on the historical record of sub-problems, the intermediate goal to one or more historical sub-problems; determining, based on the comparing, a set of historical sub-problems corresponding to the intermediate goal; and updating, based on the set of historical sub-problems, a selection policy for achieving the objective.

(M53) The method as described in any of paragraphs (M43) through (M52), further comprising bootstrapping the forward induction and the backward induction with an initial oracle-based forward induction, wherein the initial oracle-based forward induction chooses actions based on unobserved information about a real or simulated world state.

(M54) The method as described in any of paragraphs (M43) through (M53), further comprising effecting, via an actuator, the one or more optimal actions.

(M55) The method as described in any of paragraphs (M43) through (M54), wherein the computational unit supports calculation of multi-valued functions.

(M56) The method as described in any of paragraphs (M43) through (M55), further comprising restricting numerical calculations performed by the computational unit to a local data manifold within a full-dimensional space of states.

The following paragraphs (A1) describes examples of computing systems that may be implemented in accordance with the present disclosure.

(A1) A computing system comprising: one or more processors; memory storing computer executable instructions that, when executed by the processor, cause the computing system to perform the method as described in any of paragraphs (M1) through (M56).

The following paragraph (S1) describes examples of systems of devices that may be implemented in accordance with the present disclosure.

(S1) A system comprising: a computing device configured to perform the method as described in any of paragraphs (M1) through (M56); and a sensor configured to receive observational information corresponding to an objective.

The following paragraph (CRM1) describes examples of computer-readable media that may be implemented in accordance with the present disclosure.

(CRM1) One or more non-transitory computer-readable media storing instructions that, when executed by a computing system comprising at least one processor, a communication interface, and memory, cause the computing system to perform the method as described in any one of paragraphs (M1) through (M56).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
identifying, by a computational unit, an objective;
generating one or more initial probability distributions corresponding to an initial uncertainty of a real or simulated world state;
generating a selection policy, wherein the selection policy comprises one or more parameters for determining optimal actions to achieve the objective with an optimized chosen statistic of a distribution of future cost;
determining, through a coupled induction loop and based on the one or more initial probability distributions, one or more optimal actions to achieve the objective with the optimized chosen statistic, wherein the coupled induction loop comprises:
performing a backward induction on the optimized chosen statistic;
performing a forward induction on an uncertainty about an unknown state of the world;
updating, based on the backward induction and the forward induction, the selection policy; and
repeating the backward induction, the updating, and the forward induction until convergence is identified; and
outputting an indication of the one or more optimal actions.

2. The method of claim 1, further comprising:
determining a first number t, which represents a future time;
determining a first vector x, which represents an unknown state of a real or simulated world at time t;
determining a second vector y, which represents an observable state at time t;
determining a first function M(x), which is a measurement function corresponding to the second vector y; and
determining a cost function corresponding to the observable state,
wherein identifying the objective comprises defining the objective based on the first number t, the first vector x, the second vector y, the first function M(x), and the cost function.

3. The method of claim 2, further comprising:
determining a sequence of vectors i, wherein the series of vectors i represents one or more historical observable states;
determining, based on the first vector x and the series of vectors i, lifted dynamics of the selection policy;
determining, based on the lifted dynamics of the selection policy, an uninformed probability distribution p(t), wherein the uninformed probability distribution p(t) corresponds to the one or more initial probability distributions; and
deriving, based on the uninformed probability distribution, the forward induction.

4. The method of claim 3, further comprising:
determining a value function v(t)(x,i), wherein an expectation of the value function v(t)(x,i) is defined by:
$$V ( s ( t ) ) = {E}_{s ( t )} [ x \to v ( t ) ( x , i ( t ) ) ] = {E}_{p ( t )} [ v ( t ) \vert i ( t ) ] ;$$
inputting the value function v(t)(x,i) into a global backward induction yielding:
$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$
and
deriving, based on inputting the value function v(t)(x,i) into the global backward induction, the backward induction.

5. The method of claim 4, wherein updating the selection policy comprises optimizing, based on the uninformed probability distribution p(t) and the value function v(t)(x,i), the selection policy.

6. The method of claim 1, wherein the optimized chosen statistic comprises:
a percentile distribution of expected future costs for achieving the objective,
a maximum total future cost,
an expectation of the total future cost, or
an average of a subset of expected future costs for achieving the objective.

7. The method of claim 1, further comprising:
receiving, by a sensor, a current observation corresponding to the real or simulated world state;
updating, based on the current observation, historical observable state information;
determining, based on the historical observable state information, a relevance score for the current observation, wherein the relevance score comprises statistics of a current cost and a statistic of a distribution of future cost of performing one or more actions;
generating, based on the relevance score, one or more mathematical representations of emotions; and
compressing, based on the one or more mathematical representations of emotions, the historical observable state information,
wherein performing the forward induction comprises determining, based on the compressed historical observable state information, informed state distributions for the real or simulated world state.

8. The method of claim 1, further comprising:
determining, based on the one or more parameters, one or more optimal dimensions for computing the one or more optimal actions;
generating, based on the one or more optimal dimensions, one or more updated probability distributions corresponding to a state of the world; and
updating, during the coupled induction loop and based on the one or more updated probability distributions, the forward induction and the backward induction.

9. The method of claim 1, further comprising:
determining an initial particle distribution, wherein the initial particle distribution corresponds to:
information of an unknown state of a real or simulated world at a time t;
information of an uninformed probability distribution p(t),
information of one or more historical observable states,
an indication of the selection policy, and
a value function corresponding to the objective;
performing a multi-scaling method, wherein the multi-scaling method comprises:
scaling up interaction distances and speeds of motion in world mechanics corresponding to the one or more initial probability distributions;
identifying a subset of particles of the initial particle distribution;
interpolating the subset of particles; and
repeating the scaling, identifying subsets of particles, and interpolating until an optimal number of scales is achieved; and
updating, based on completion of the multi-scaling method, the coupled induction loop.

10. The method of claim 1, further comprising:
generating, based on optimal actions for achieving historical objectives, a historical record of sub-problems for historical objectives;
determining an intermediate goal for the objective;
comparing, based on the historical record of sub-problems, the intermediate goal to one or more historical sub-problems;
determining, based on the comparing, a set of historical sub-problems corresponding to the intermediate goal; and
updating, based on the set of historical sub-problems, the selection policy.

11. The method of claim 1, further comprising bootstrapping the forward induction and the backward induction with an initial oracle-based forward induction, wherein the initial oracle-based forward induction chooses actions based on unobserved information about the real or simulated world state.

12. The method of claim 1, further comprising effecting, via an actuator, the one or more optimal actions.

13. The method of claim 1, wherein the computational unit supports calculation of multi-valued functions.

14. The method of claim 1, further comprising restricting numerical calculations performed by the computational unit to a local data manifold within a full-dimensional space of states.

15. A method comprising:
receiving, by a sensor, observational information;
maintaining, by a computational unit, an objective;
maintaining, by the computational unit, a current uncertainty about an unknown state, wherein the current uncertainty is updated using the observational information;
generating a selection policy, wherein the selection policy comprises one or more parameters for determining optimal actions to achieve the objective with an optimized chosen statistic of a distribution of future cost; and
determining, by the computational unit and based on the selection policy, one or more optimal actions to achieve the objective as an optimal value of the optimized chosen statistic, wherein said determining comprises performing both backward induction on the optimized chosen statistic and forward induction on the uncertainty about the unknown state.

16. The method of claim 15, further comprising:
determining a first number t, which represents a future time;
determining a first vector x, which represents an unknown state of a real or simulated world at time t;
determining a second vector y, which represents an observable state at time t;
determining a first function M(x), which is a measurement function corresponding to the second vector y; and
determining a cost function corresponding to the observable state,
wherein maintaining the objective comprises defining the objective based on the first number t, the first vector x, the second vector y, the first function M(x), and the cost function.

17. The method of claim 16, further comprising:
determining a sequence of vectors i, wherein the series of vectors i represents one or more historical observable states;
determining, based on the first vector x and the series of vectors i, lifted dynamics of the selection policy;
determining, based on the lifted dynamics of the selection policy, an uninformed probability distribution p(t), wherein the uninformed probability distribution p(t) corresponds to one or more initial probability distributions; and
deriving, based on the uninformed probability distribution, the forward induction.

18. The method of claim 17, further comprising:
determining a value function v(t)(x,i), wherein an expectation of the value function v(t)(x,i) is defined by:
$$V ( s ( t ) ) = {E}_{s ( t )} [ x \to v ( t ) ( x , i ( t ) ) ] = {E}_{p ( t )} [ v ( t ) \vert i ( t ) ] ;$$
inputting the value function v(t)(x,i) into a global backward induction yielding:
$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$
and
deriving, based on inputting the value function v(t)(x,i) into the global backward induction, the backward induction.

19. The method of claim 18, wherein determining the one or more actions comprises optimizing, based on the uninformed probability distribution p(t) and the value function v(t)(x,i), the selection policy.

20. The method of claim 15, wherein the optimized chosen statistic comprises:
a percentile distribution of expected future costs for achieving the objective,
a maximum total future cost,
an expectation of the total future cost, or
an average of a subset of expected future costs for achieving the objective.

21. The method of claim 15, further comprising:
receiving, by the sensor, a current observation corresponding to the real or simulated world state;
updating, based on the current observation, historical observable state information;
determining, based on the historical observable state information, a relevance score for the current observation, wherein the relevance score comprises statistics of a current cost and a statistic of a distribution of future cost of performing one or more actions;
generating, based on the relevance score, one or more mathematical representations of emotions; and
compressing, based on the one or more mathematical representations of emotions, the historical observable state information,
wherein performing the forward induction comprises determining, based on the compressed historical observable state information, informed state distributions for the real or simulated world state.

22. The method of claim 15, further comprising:
determining, based on the one or more parameters, one or more optimal dimensions for computing the one or more optimal actions;
generating, based on the one or more optimal dimensions, one or more updated probability distributions corresponding to a state of the world; and
updating, during the determining the one or more optimal actions and based on the one or more updated probability distributions, the forward induction and the backward induction.

23. The method of claim 15, further comprising:
determining an initial particle distribution, wherein the initial particle distribution corresponds to:
information of an unknown state of a real or simulated world at a time t;
information of an uninformed probability distribution p(t),
information of one or more historical observable states,
an indication of the selection policy, and
a value function corresponding to the objective;
performing a multi-scaling method, wherein the multi-scaling method comprises:
scaling up interaction distances and speeds of motion in world mechanics corresponding to the one or more initial probability distributions;
identifying a subset of particles of the initial particle distribution;
interpolating the subset of particles; and
repeating the scaling, identifying subsets of particles, and interpolating until an optimal number of scales is achieved; and
updating, based on completion of the multi-scaling method, the backward induction and the forward induction.

24. The method of claim 15, further comprising:
generating, based on optimal actions for achieving historical objectives, a historical record of sub-problems for historical objectives;
determining an intermediate goal for the objective;
comparing, based on the historical record of sub-problems, the intermediate goal to one or more historical sub-problems;
determining, based on the comparing a set of historical sub-problems corresponding to the intermediate goal; and
updating, based on the set of historical sub-problems, the selection policy.

25. The method of claim 15, further comprising bootstrapping the forward induction and the backward induction with an initial oracle-based forward induction, wherein the initial oracle-based forward induction chooses actions based on unobserved information about the real or simulated world state.

26. The method of claim 15, further comprising effecting, via an actuator, the one or more optimal actions.

27. The method of claim 15, wherein the computational unit supports calculation of multi-valued functions.

28. The method of claim 15, further comprising restricting numerical calculations performed by the computational unit to a local data manifold within a full-dimensional space of states.

29. A method for optimizing acquisition of data, in furtherance of an objective, comprising:
maintaining, by a computational unit, the objective;
representing the objective using an incremental cost of a plurality of potential actions,
wherein the plurality of potential actions comprises one or more actions associated with an optimal contingent strategy for achieving the objective as an optimal value of an optimized chosen statistic of a distribution of future cost that, when performed, produce observational information;
acquiring, via one or more sensors, based on performing, during execution of the optimal contingent strategy, the one or more actions and based on prior observational information acquired by the one or more sensors, the observational information;
providing, to a model that is selecting the optimal contingent strategy, the observational information, wherein providing the observational information configures the model to determine one or more optimal future actions for achieving the objective; and
determining, by the computational unit and using the model, one or more optimal future actions to achieve the objective, wherein the determining the one or more optimal future actions comprises repeating a backward induction and a forward induction until convergence is identified.

30. The method of claim 29, further comprising:
determining a first number t, which represents a future time;
determining a first vector x, which represents an unknown state of a real or simulated world at time t;
determining a second vector y, which represents an observable state at time t;
determining a first function M(x), which is a measurement function corresponding to the second vector y; and
determining a cost function corresponding to the observable state,
wherein maintaining the objective comprises defining the objective based on the first number t, the first vector x, the second vector y, the first function M(x), and the cost function.

31. The method of claim 30, further comprising:
determining a sequence of vectors i, wherein the series of vectors i represents one or more historical observable states;
determining, based on the first vector x and the series of vectors i, lifted dynamics of the selection policy;
determining, based on the lifted dynamics of the selection policy, an uninformed probability distribution p(t), wherein the uninformed probability distribution p(t) corresponds to the one or more initial probability distributions; and
deriving, based on the uninformed probability distribution, the forward induction.

32. The method of claim 31, further comprising:
determining a value function v(t)(x,i), wherein an expectation of the value function v(t)(x,i) is defined by:
$$V ( s ( t ) ) = {E}_{s ( t )} [ x \to v ( t ) ( x , i ( t ) ) ] = {E}_{p ( t )} [ v ( t ) \vert i ( t ) ] ;$$
inputting the value function v(t)(x,i) into a global backward induction yielding:
$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$
and
deriving, based on inputting the value function v(t)(x,i) into the global backward induction, the backward induction.

33. The method of claim 32, wherein the determining the one or more optimal actions comprises optimizing, based on the uninformed probability distribution p(t) and the value function v(t)(x,i), a selection policy.

34. The method of claim 29, wherein the optimized chosen statistic comprises:
a percentile distribution of expected future costs for achieving the objective,
a maximum total future cost,
an expectation of the total future cost, or
an average of a subset of expected future costs for achieving the objective.

35. The method of claim 29, further comprising:
receiving, by the one or more sensors, a current observation corresponding to a real or simulated world state;
updating, based on the current observation, historical observable state information;
determining, based on the historical observable state information, a relevance score for the current observation, wherein the relevance score comprises statistics of a current cost and a statistic of a distribution of future cost of performing one or more actions;
generating, based on the relevance score, one or more mathematical representations of emotions; and
compressing, based on the one or more mathematical representations of emotions, the historical observable state information,
wherein performing the forward induction comprises determining, based on the compressed historical observable state information, informed state distributions for the real or simulated world state.

36. The method of claim 29, further comprising:
determining, based on one or more parameters for determining optimal actions, one or more optimal dimensions for computing the one or more optimal actions;
generating, based on the one or more optimal dimensions, one or more updated probability distributions corresponding to a state of the world; and
updating, during the determining the one or more optimal actions and based on the one or more updated probability distributions, the forward induction and the backward induction.

37. The method of claim 29, further comprising:
determining an initial particle distribution, wherein the initial particle distribution corresponds to:
information of an unknown state of a real or simulated world at a time t;
information of an uninformed probability distribution p(t),
information of one or more historical observable states,
an indication of the selection policy, and
a value function corresponding to the objective;
performing a multi-scaling method, wherein the multi-scaling method comprises:
scaling up interaction distances and speeds of motion in world mechanics corresponding to the one or more initial probability distributions;
identifying a subset of particles of the initial particle distribution;
interpolating the subset of particles; and
repeating the scaling, identifying subsets of particles, and interpolating until an optimal number of scales is achieved; and
updating, based on completion of the multi-scaling method, the forward induction and the backward induction.

38. The method of claim 29, further comprising:
generating, based on optimal actions for achieving historical objectives, a historical record of sub-problems for historical objectives;
determining an intermediate goal for the objective;
comparing, based on the historical record of sub-problems, the intermediate goal to one or more historical sub-problems;
determining, based on the comparing a set of historical sub-problems corresponding to the intermediate goal; and
updating, based on the set of historical sub-problems, a selection policy for achieving the objective.

39. The method of claim 29, further comprising bootstrapping the forward induction and the backward induction with an initial oracle-based forward induction, wherein the initial oracle-based forward induction chooses actions based on unobserved information about a real or simulated world state.

40. The method of claim 29, further comprising effecting, via an actuator, the one or more optimal actions.

41. The method of claim 29, wherein the computational unit supports calculation of multi-valued functions.

42. The method of claim 29, further comprising restricting numerical calculations performed by the computational unit to a local data manifold within a full-dimensional space of states.

43. A method for constructing an efficient memory, in furtherance of an objective, comprising:
maintaining, by a computational unit, the objective;
representing the objective using an incremental cost of a plurality of potential actions;
acquiring observational data, directly or indirectly, as a result of performing the plurality of potential actions;
selecting a subset of the observational data to include in a memory unit based on one or more statistics of a distribution of total current and future cost at the time that the data is acquired; and
determining, by the computational unit and based on the subset of the observational data, one or more optimal actions to achieve the objective as an optimal value of an optimized chosen statistic of a distribution of future cost, wherein determining the one or more optimal actions comprises repeating a backward induction and a forward induction until convergence is identified.

44. The method of claim 43, further comprising:
determining a first number t, which represents a future time;
determining a first vector x, which represents an unknown state of a real or simulated world at time t;
determining a second vector y, which represents an observable state at time t;
determining a first function M(x), which is a measurement function corresponding to the second vector y; and
determining a cost function corresponding to the observable state,
wherein maintaining the objective comprises defining the objective based on the first number t, the first vector x, the second vector y, the first function M(x), and the cost function.

45. The method of claim 44, further comprising:
determining a sequence of vectors i, wherein the series of vectors i represents one or more historical observable states;
determining, based on the first vector x and the series of vectors i, lifted dynamics of a selection policy;
determining, based on the lifted dynamics of the selection policy, an uninformed probability distribution p(t), wherein the uninformed probability distribution p(t) corresponds to the one or more initial probability distributions; and
deriving, based on the uninformed probability distribution, the forward induction.

46. The method of claim 45, further comprising:
determining a value function v(t)(x,i), wherein an expectation of the value function v(t)(x,i) is defined by:
$$V ( s ( t ) ) = {E}_{s ( t )} [ x \to v ( t ) ( x , i ( t ) ) ] = {E}_{p ( t )} [ v ( t ) \vert i ( t ) ] ;$$
inputting the value function v(t)(x,i) into a global backward induction yielding:
$${E}_{p ( t )} [ v ( t ) ( x , i ) \vert i ( t ) ] = {min}_{a ( i ( t ) )} \{ C ( y ( t ) , a ( i ( t ) ) ) + {E}_{i ( t + 1 )} {E}_{p ( t + 1 )} [ v ( t + 1 ) \vert i ( t + 1 ) ] \} = {min}_{a ( i ( t ) )} {E}_{p ( t )} [ C ( y , a ( i ( t ) ) ) + v ( t + 1 ) ( A ( x , a ( i ) ) , B ( x , a ( i ) ) ) \vert i ( t ) ] ;$$
and
deriving, based on inputting the value function v(t)(x,i) into the global backward induction, the backward induction.

47. The method of claim 46, wherein the determining the one or more optimal actions comprises optimizing, based on the uninformed probability distribution p(t) and the value function v(t)(x,i), the selection policy.

48. The method of claim 43, wherein the optimized chosen statistic comprises:
a percentile distribution of expected future costs for achieving the objective,
a maximum total future cost,
an expectation of the total future cost, or
an average of a subset of expected future costs for achieving the objective.

49. The method of claim 43, further comprising:
receiving, by one or more sensors, a current observation corresponding to a real or simulated world state;
updating, based on the current observation, historical observable state information;
determining, based on the historical observable state information, a relevance score for the current observation, wherein the relevance score comprises statistics of a current cost and a statistic of a distribution of future cost of performing one or more actions;
generating, based on the relevance score, one or more mathematical representations of emotions; and
compressing, based on the one or more mathematical representations of emotions, the historical observable state information,
wherein performing the forward induction comprises determining, based on the compressed historical observable state information, informed state distributions for the real or simulated world state.

50. The method of claim 43, further comprising:
determining, based on one or more parameters for determining optimal actions, one or more optimal dimensions for computing the one or more optimal actions;
generating, based on the one or more optimal dimensions, one or more updated probability distributions corresponding to a state of the world; and
updating, during the determining the one or more optimal actions and based on the one or more updated probability distributions, the forward induction and the backward induction.

51. The method of claim 43, further comprising:
determining an initial particle distribution, wherein the initial particle distribution corresponds to:
information of an unknown state of a real or simulated world at a time t;
information of an uninformed probability distribution p(t),
information of one or more historical observable states,
an indication of a selection policy, and
a value function corresponding to the objective;
performing a multi-scaling method, wherein the multi-scaling method comprises:
scaling up interaction distances and speeds of motion in world mechanics corresponding to the one or more initial probability distributions;
identifying a subset of particles of the initial particle distribution;
interpolating the subset of particles; and
repeating the scaling, identifying subsets of particles, and interpolating until an optimal number of scales is achieved; and
updating, based on completion of the multi-scaling method, the forward induction and the backward induction.

52. The method of claim 43, further comprising:
generating, based on optimal actions for achieving historical objectives, a historical record of sub-problems for historical objectives;
determining an intermediate goal for the objective;
comparing, based on the historical record of sub-problems, the intermediate goal to one or more historical sub-problems;
determining, based on the comparing a set of historical sub-problems corresponding to the intermediate goal; and
updating, based on the set of historical sub-problems, a selection policy for achieving the objective.

53. The method of claim 43, further comprising bootstrapping the forward induction and the backward induction with an initial oracle-based forward induction, wherein the initial oracle-based forward induction chooses actions based on unobserved information about a real or simulated world state.

54. The method of claim 43, further comprising effecting, via an actuator, the one or more optimal actions.

55. The method of claim 43, wherein the computational unit supports calculation of multi-valued functions.

56. The method of claim 43, further comprising restricting numerical calculations performed by the computational unit to a local data manifold within a full-dimensional space of states.
